(19) United States
(12) Patent Application Publication
(10) Pub. No.: US 2013/0060788 A1
(43) Pub. Date: Mar. 7, 2013

(54) Methods for recognition of multidimensiional patterns cross-reference to related applications

(71) Applicant: Jezekiel Ben-Arie, Chicago, IL (US)

(72) Inventor: Jezekiel Ben-Arie, Chicago, IL (US)

(21) Appl. No.: 13/573,231

(22) Filed: Sep. 1, 2012

Related U.S. Application Data
(60) Provisional application No. 61/573,208, filed on Sep. 1, 2011.

(51) Int. Cl. G06F 17/30

(52) U.S. Cl. 707/749; 707/E17.001

(57) ABSTRACT

A method implemented by a computer for recognition of multidimensional patterns, represented by multidimensional arrays of multidimensional vectors which are derived from data collected from speech, images, video, signals, static physical entities or moving physical entities. The recognition is based on classification into pattern classes. For the classification the invention provides efficient methods for the computation of similarity measures between input patterns and stored patterns. Usually, input patterns are acquired by sensors and their class is unknown. They are classified by finding the stored pattern class with the highest similarity measure to the input pattern. For speech and image recognition, the methods provide additional innovations which improve the reliability. Speech is represented by one dimensional arrays of multidimensional vectors. These arrays represent continuous speech our methods have novel means for separating the signal into words and phonemes. New penalty functions improve false positives and correct recognition rates. Similar approach is used for images and video.

### CROSS-REFERENCE TO RELATED APPLICATIONS

This application claims the benefit of a provisional patent application:

Ser. No. 61/573,208

### FEDERALLY SPONSORED RESEARCH

Not Applicable

### SEQUENCE LISTING OR PROGRAM

Not Applicable

### BACKGROUND OF THE INVENTION

### Prior Art

This invention relates to a method implemented by a computer for the computation of similarity measures between input patterns and stored patterns wherein both input patterns and the stored patterns are derived from data collected from speech or images or video or signals or static physical entities or moving physical entities. The similarity measures obtained can then be used to classify the input patters as similar to one of the classes of the stored patterns. For example, if the input patterns are derived from speech, the method can classify segments of the speech into words by detecting high similarity measures of the input speech to stored exemplar words. In other applications, the method can identify faces in images, classify human actions in video or even classify patterns of weather, human genome etc. In all the applications, both input and stored patterns are converted into arrays of vectors, which are then classified by an algorithm that computes their mutual similarity measures. Our invention is an algorithm that we call VARIS which stands for: “Vector Array Recognition by Indexing and Sequencing”. VARIS has many advantages over currently widely used classification methods such as “Hidden Markov Models” (HMM) or “Dynamic Time Warping” DTW. Unlike HMM and DTW, which can be used only in classification of patterns such as speech, which are represented by one dimensional arrays of vectors, VARIS can classify any dimensional arrays of vectors with polynomial computation complexity. Whereas HMM and DTW have exponential complexity even in just two dimensions. VARIS has many other advantages over HMM such as ease of training, which enables to easily adapt each speech recognizer to any speaker with any accent and with any language. Recognition rates are much higher and much faster.

### U.S. PATENTS

[6] U.S. Pat. No. 7,366,645, B2, April 2008, J. Ben-Arie, “Method of Recognition of Human Motion, Vector Sequences and Speech”.
   My patent search on the key words “multidimensional”+“recognition” or “multidimensional”+“pattern” showed zero results. So I could not find any invention that deals with multidimensional pattern recognition, which is the main topic of my invention. I also conducted a search on “adaptive speech recognition” I found the following patents:

Adaptive Speech Recognition—In Title:

1. U.S. Pat. No. 7,996,218 Aug. 9, 2011 User adaptive recognition method and apparatus
2. U.S. Pat. No. 7,003,460 Feb. 21, 2006 Method and apparatus for an adaptive speech recognition system utilizing HMM models
3. U.S. Pat. No. 6,662,160 Dec. 9, 2003 Adaptive speech recognition method with noise compensation
4. U.S. Pat. No. 6,418,411 Jul. 9, 2002 Method and system for adaptive speech recognition in noisy environment
5. U.S. Pat. No. 6,278,968 Aug. 21, 2001 Method and apparatus for adaptive speech recognition hypothesis construction and selection in a spoken language translation system
6. U.S. Pat. No. 6,044,343 Mar. 28, 2000 Adaptive speech recognition with selective input data to a speech classifier
7. U.S. Pat. No. 5,774,841 Jun. 30, 1998 Real-time reconfigurable adaptive speech recognition command and control apparatus and method
8. U.S. Pat. No. 5,170,432 Dec. 8, 1992 Method of speaker adaptive speech recognition

Additional Adaptive Speech Recognition—In Abstract

1. U.S. Pat. No. 6,208,964 Mar. 27, 2001 Method and apparatus for providing unsupervised adaptation of transcription
2. U.S. Pat. No. 4,720,802 Jan. 19, 1988 Noise compensation arrangement

In all these inventions the authors use either HMM (Hidden Markov Models) or DTW (Dynamic Time Warping) as the basic recognition approach. As will be elaborated below, these methods are entirely different from my invented method. Similarly, the most relevant patent applications were also on HMM principles:

20110066426 Real time speaker adaptive speech recognition apparatus and method
20060200347 User adaptive speech recognition method and apparatus
20060184360 Adaptive multi-pass speech recognition system
20030187645 Automatic detection of change in speaker in speaker adaptive speech recognition system.

### NONPATENT LITERATURE DOCUMENTS

[1] J. Ben-Arie, Z. Wang, P. Pandit, and S. Rajaram. Human Activity Recognition using Multidimensional Indexing. IEEE Transactions in Pattern Analysis and Machine Intelligence, Vol. 24, No. 8, pp 1091-1105, August 2002.
[2] S. Franzini and J. Ben-Arie. Speech recognition by indexing and sequencing. In Soft Computing and Pattern Recognition (SoCPaR), 2010 International Conference of, pages 93-98, dec. 2010.
[3] S. Franzini and J. Ben-Arie, “Speech Recognition by Indexing and Sequencing,” International Journal of Computer Information Systems and Industrial Management Applications. ISSN 2150-7988 Volume 3, December (2011).
[4] Kai Ma and J. Ben-Arie, “Vector Array based Multi-view Face Detection with Compounded Exemplars,” in IEEE CVPR 2012, Providence, R.I., June 2012.
[5] Kai Ma and J. Ben-Arie, “Multi-view Multi-class Object Detection via Exemplar Compounding,” to appear in IEEE ICPR 2012, Tsukuba, Japan, November 2012.

Hence, I find that my invention is entirely novel with respect to other inventors. The only invention that bears some similarity to a part of my current invention is my own U.S. Pat. No. 7,366,645 B2 which describes the old version of RISq (Recognition by Indexing and Sequencing). However, RISq can recognize only one dimensional arrays of multidimensional vectors and was developed for human activity recognition [1]. The new invention is called VARIS (Vector Array Recognition by Indexing and Sequencing) and deals with multidimensional arrays of multidimensional vectors. VARIS employs an improved version of RISq with several unobvious innovations called 1D algorithm and in a recursive application, it is entirely non obvious and took me years to invent and develop. The recursive application enables to reduce the array's dimension by one in each recursive iteration, resulting finally with a similarity measures between multidimensional arrays. The extension to multidimensional arrays opens a whole new space for multidimensional vector array pattern recognition. As far as I investigated, my method is the only one that solves this enormously difficult problem in polynomial complexity of computations. Measuring similarity of multidimensional arrays enables in the first time to recognize physical phenomena such as videos invariant to their speed and distortion.

Description of VARIS (Vector Array Recognition by Indexing and Sequencing):

VARIS (U.S. provisional Patent 61/573,208)—is a Methodology for exemplar based Detection and Recognition/classification of signals that are represented by multidimensional arrays of vectors, which also can be typified as Tensors or as multidimensional sequences of vectors. If the arrays are of dimension n then they are equivalent to tensors of order n+1.

Such arrays can represent many kinds of physical signals. For example, speech can be represented by 1D array of vectors, which is equivalent to 1D temporal sequence of vectors or to Tensors of order 2. Every vector in the sequence represents the spectrum of a very short segment of the speech sound waveform. Among many other applications, 1D arrays are also useful in describing human actions, gestures and other activities. Images are represented by 2D arrays (tensors of order 3). Every vector in the 2D array is representing the properties such as color and brightness of one pixel of the image. Videos can be described by 3D arrays (tensors of order 4). 3D arrays are also useful in describing complex phenomena such as weather patterns, earth quakes, etc. Higher array dimensions can describe even more complex physical phenomena.

In this patent application, I describe a computer methodology that enables to detect and classify such signals with Robustness to Interference, Geometric Distortions and Incomplete Data. VARIS is actually a multidimensional extension of a 1D algorithm, which is an improvement of a method called RISq (Recognition by Indexing and Sequencing). A preliminary version of RISq was invented by me in 2000 and patented in 2008 [6]. RISq is designed to recognize 1D arrays of vectors and is described in detail in the following section.

The recognition of multidimensional arrays by VARIS is achieved by a recursive application of a 1D algorithm on the input array, each time on another dimension of the array. VARIS achieves better generic detection by incorporating in each class several exemplars that represent different instances of the same class. For example, in face detection, one can store many types of faces as stored exemplars. This enables to detect large variations of face appearances. The detection/recognition is further improved by introducing new similarity measures that penalize incompatible input-exemplar vector pairs in the arrays matched. Additional significant improvement is achieved by our new compounding approach. In this approach, each exemplar is divided into components in a way that enables to create new exemplars by compounding parts from several exemplars of the same class. Experimental results of a comparison between the performances of VARIS versus 3 of the best face detection methods, is illustrated in [4][5]. The comparison shows that the performance of VARIS is better both in recognition rates and in false detection rates.

Description of RISq:

RISq is a method for Detection or Recognition of 1D arrays of multidimensional vectors [6]. A more advanced version of RISq called 1D algorithm is being used in VARIS. Three innovative additions that are included in 1D algorithm are described in the section on speech recognition. The problem of detection and classification of patterns that are expressed by arrays of vectors is different and more difficult than classification of single vectors by classical Pattern Recognition (PR). The classical approach for detection and classification of patterns that were composed of vector arrays was to concatenate all the vectors in the array into one long vector that could be recognized by classical PR methods. This approach is not practical because physical patterns such as speech, images or video, usually are varying in time and therefore could not be effectively represented by rigid vectors as required by classical PR. 1D signals such as speech usually are represented by 1D array of multidimensional vectors (Tensors of order 2). Each vector in the array represents a sample of the speech. Methods such as Hidden Markov Models (HMM) or Dynamic Time Warping (DTW) were developed for detection and classification of 1D arrays. DTW is rarely used today because HMM produces much better results. In following paragraphs we elucidate the differences between RISq and DTW. As demonstrated in [2][3] RISq achieves even slightly better results than HMM in recognition of speech.

HMM, is a parametric method and therefore needs rigorous training by a complex algorithm called Expectation Maximization (EM) in order to quantify the parameters of each model. In contrast, 1D algorithm is non-parametric method and needs only one exemplar per class for training. This is the reason that 1D algorithm could be very easily adapted to different speakers, Languages or accents. 1D algorithm is based on k-Nearest Neighbors (kNN) approach in which classification is performed by estimating the posterior probability, which corresponds to the similarity of each vector in the array with respect to exemplar vectors in the its neighborhood. In our opinion, non-parametric methods have a significant advantage over parametric methods because one does not need to assume any functional description for the underlying probability distributions. In practice, distributions of signals such as speech or imagery are quite complex and a-priori unknown. Assuming a functional description that does not fit the actual data could result in low recognition rates and high false positives rates (false alarm rates). In addition, the non-parametric structure of 1D algorithm is very easy to train because it does not make any attempt at building statistical models of pattern classes. Instead, training is performed by simply storing one or more exemplar arrays per class in the 1D algorithm's database.

After training is performed, an unknown input array can be classified using a two-step algorithm. The first step is indexing, which consists of identifying a number of exemplar vectors, which are closest to each input vector and assigning them weights, which are proportional to their mutual similarity measure. The second step is sequencing, which finds using dynamic programming the maximally weighted bipartite graph matching between the input array and each exemplar array, while respecting a sequencing constraint. If vectors i and j in the input sequence are matched with vectors k and l in the exemplar sequence, then if i<j then k must be smaller than l according to the sequencing constraint. The aggregate scores of the bipartite graph matching to each exemplar array are compared and the input array is classified as a member of the class of the exemplar array with the highest score.

Description of VARIS as a Recursive Application of 1D Algorithm:

The VARIS algorithm was developed for vector arrays with 2 or more dimensions (Tensors of order 3 or more). The 1D algorithm, which was designed for optimal matching of 1D arrays of vectors, is applied recursively by VARIS each time on another dimension. The result of each application is an array, which is smaller by one dimension. For example, 2D arrays are arranged as a 2D matrix of vectors. There are two options to execute the VARIS algorithm for two dimensions by switching the processing order of the rows with the columns. One could start at the first phase with matching the columns (or the rows) of the 2D input array to all the columns (rows) of the exemplars, which are also 2D arrays. At the first phase, RISq finds the optimal similarity scores of each column of the input 2D array with all the columns of the exemplars. This task is not insurmountable because most of the exemplar columns do not have vectors which are close enough to the input vectors to be indexed. At second phase, each column of the input and of the exemplars is collapsed into a node in a 1D array. Next, the input 2D array is reduced into a 1D array. Similarly, each 2D exemplar is also reduced into 1D array. As a consequence of 1D algorithm finding similarity scores between each input column to all the columns of the exemplars in the first phase, each input node has similarity scores to each of the nodes of the exemplars. Next, 1D algorithm is applied again with the goal to find the collapsed 1D exemplar array that best matches the collapsed 1D input array. 1D algorithm now finds the optimal aggregate similarity scores of the input array with each of the exemplars. The input array is then classified as a member of the class of the exemplar with the highest similarity score.

The application of 1D algorithm finds the optimal, mutual similarity score between two 1D arrays while allowing any warping that abides by the sequencing constraint. In this 2D example, the sequencing constraint in 1D algorithm's optimization is applied twice. At first phase, the row number of each vector in the columns of the input and the exemplars' arrays serves as its 1D “timing” within the column. In the second phase, the “timing” is the column number of each collapsed column of both the input and the exemplars' arrays. This two tier sequencing allows a wide range of 2D warping, which still preserves the topology of the matches of the input array with the exemplar arrays. This enables to recognize humans and objects that are depicted in a wide divergence of viewpoints. The segmentation of the 2D input and exemplar images into arrays of independent vectors, where each vector represents a small image patch, enables VARIS to include in the aggregate similarity score only patches that belong to the subject and reject patches of the background and of other objects. Therefore, VARIS which is based on recursive application of 1D algorithm, is more robust in conditions of partial occlusion and missing image data.

To improve VARIS's generalization in detection and classification, I included in each class several exemplars, which represent as much as possible the variety of members within each class. Very recently I introduced a new approach which we call “exemplar compounding” [3][4][5]. In order to achieve even more flexibility and adaptability in each class, I developed algorithms that construct 2D optimal exemplars which are composed of patches of different members of the same class. Compounding provides more flexibility and higher similarity scores with relatively smaller exemplar sets. In experiments of person detection in images, VARIS with compounded exemplars achieved better results than any State Of the Art (SOA) detection method including VARIS with uncompounded exemplar. I developed compounding algorithms also for speech [3] in which word exemplars are composed of partial utterances of several people.

Claims 1-8 describe the general multidimensional VARIS method. Claims 15-19 describe VARIS applied for 2D arrays, which is useful for tasks such as face detection or object recognition in imagery. Claims 9-14 describe my new approach of using VARIS for 1D arrays. A task especially suited for adaptive continuous speech recognition. These claims include three innovative additions. The first is the introduction of negative similarity scores to segments that do not match the exemplars. This is an important addition that noticeably reduces the false positives rates because there are many cases where different words with similar features get high similarity scores unjustifiably. The second innovation is the segmentation of the continuous speech by matching the speech stream with overlapping segments with lengths that correspond to different word groups. The problem of continuous speech segmentation is very difficult because it is impossible to segment the speech by detecting silent periods, which are absent in continuous speech. Here both HMM and DTW fail because these methods require to specify the beginnings and ends of each word one intents to classify. The third innovation is in introducing a method for segmenting the phonemes in the stored and input words and pruning all the words which have even a single non-matching phoneme. This further reduces the false alarm rates. The first and second innovations were also included in the multidimensional VARIS claims as well.

Differences between DTW (Dynamic Time Warping) and 1D algorithm

DTW is a method for recognizing an input of 1D sequence of vectors as most similar to one of stored exemplars of 1D sequences of vectors. DTW algorithm optimizes the sum of vector distances between the two sequences using Dynamic Programming (DP). The algorithm allows time warping in which the sequences are shrunk or stretched to improve matching with the other sequence. This provides more flexible matching in cases where the timing of the two sequences is not compatible. The warping of an input sequence with M vectors, matched to an exemplar sequence of N vectors, can be represented by a path in a rectangular lattice which has M rows and N columns. Each junction (k,l) has a cost which is proportional to the distance between the k-th input vector to the l-th exemplar vector. DTW tries to find a monotonically connected path from (1,1) to (M,N) that has minimum cumulative cost=distance. The requirement of monotonous paths means that all the pieces of the path from say junction (k,l) to (h,j) must have k−h≦0 and l−j≦0. DTW has many uses mostly for speech recognition. In speech, the input and the exemplars are sequences of vectors, which are composed of Mel Frequency Cepstrum Coefficients (MFCCs) that are derived by sampling and processing signals of speech utterances. Although there are few similarities between DTW and 1D algorithm there are significant differences between the two. The two methods are superficially similar because both methods match vector sequences while allowing warping and both methods use DP to find the optimal matching score. But here the similarity ends. Firstly, DTW regards the absolute vector distances as an inverse similarity measure and tries to find the match between the sequences which has the minimal cumulative distance using DP, which is constrained by monotonic sequencing requirement. But the sequences must be matched according to a connected and monotonic path. On the other hand, 1D algorithm performs bipartite graph matching, which allows partial matching of both input and exemplar sequences in any sequential configuration i.e. the path could be disconnected. This provides much more flexibility in warping and improves 1D algorithm's and VARIS's recognition rates noticeably. Such a process is feasible because both RISq and VARIS are accumulating vector similarities not distances. RISq and VARIS also penalize dissimilarities while DTW uses only distance penalties. The similarity-dissimilarity scoring in 1D algorithm and in VARIS provide a substantial improvement in performance. Similarity and distance have inverse relations. Mathematically, there is a non linear and inverse relation between the two. However, minimizing accumulated distances is not the same as maximizing accumulated similarities. In addition, DTW must determine the endpoints of both sequences (also HMM). 1D algorithm and VARIS do not have to. This discrepancy alone could make a lot of difference in the recognition rates because DTW must apply pre-segmentation to locate these end points, a process which is very much error prone especially in continuous speech. Another substantial difference: with DTW one has to match all the exemplars serially one by one, in order to find the best match. This makes DTW much slower especially if it has many exemplars (HMM has the same problem). In contrast, VARIS is a parallel method that employs indexing and matches all the exemplars at once. Furthermore, a most important difference is that VARIS can recognize multidimensional sequences in polynomial complexity at any dimension. Whereas DTW can deal only with 1D sequences and has NP complete complexity even with 2D sequences (HMM has also exponential complexity in 2D). To conclude, all these differences result in much better performance of 1D algorithm and VARIS in recognition rates, in False alarm rates and in computation time requirements.

I claim

1. A method implemented by a computer for the computation of similarity measures between input patterns and stored patterns wherein both said input patterns and said stored patterns are derived from data collected from speech, images, video, signals, static physical entities or moving physical entities wherein said input patterns are represented by input arrays of input vectors wherein said input arrays have at least one dimension wherein input vectors have at least one dimension, wherein said stored patterns are represented by stored arrays of stored vectors wherein said stored arrays have at least one dimension wherein said stored vectors have at least one dimension, wherein said input array is denoted by [A^{u}] wherein: [A]^{u}={a^{u}ᵢ_{₁}_{. . . i}_{_{q}}|i₁=1, 2, . . . , k₁^{u}; i₂=1, 2, . . . , k₂^{u}; . . . ; i_{q}=1, 2, . . . , k_{q}^{u}} wherein u denotes the serial number of said input array wherein q≧1 denotes the number of dimensions of said input arrays wherein q≧1 denotes also the number of dimensions of said stored arrays which is equal to said number of dimensions of said input arrays, wherein aᵢ_{₁}_{. . . i}_{_{q}}^{u} denotes said input vectors wherein i₁ . . . i_{q} denote the indices which denote the serial numbers of said input vectors within each of said q dimensions, wherein k₁^{u} . . . k_{q}^{u} denote the total number of said input vectors in each of said q dimensions,
wherein each said stored array is denoted by [M^{v}^{_{c}}^{C}] wherein the set of said stored arrays is denoted by: {[M]^{v}^{_{c}}^{C}}={{mⱼ_{ₗ} . . . j_{_{q}}^{v}^{_{c}}^{C}|j₁=1, 2, . . . , l₁^{v}^{_{c}}^{C}; j₂=1, 2, . . . , l₂^{v}^{_{c}}^{C}; . . . ; j_{q}=1, 2, . . . , l_{q}^{v}^{_{c}}^{C}}} wherein c denotes the class of said stored array [M^{v}^{_{c}}^{C}] wherein c=1 . . . C; wherein C denotes the total number of said classes, wherein v_{c}=1, . . . , V_{c}; denotes the serial number of said stored array [M^{v}^{_{c}}^{C}] within said class c wherein total number of stored arrays within said class c is V_{c} wherein mⱼ_{ₗ}_{. . . j}_{_{q}}^{v}^{_{c}}^{C} denotes said stored vectors of said stored array [M^{v}^{_{c}}^{C}] wherein j₁ . . . j_{q} denote the indices of said stored vectors which denote the serial numbers of said stored vectors within each of said q dimensions, wherein l₁^{v}^{_{c}}^{C} . . . l_{q}^{v}^{_{c}}^{C} denote the total number of said stored vectors in each of said q dimensions
wherein said similarity measures {S{[A]^{u},[M]^{v}^{_{c}}^{C}}} between said input array [A]^{u} and said stored arrays {[M]^{v}^{_{c}}^{C}} are computed by a recursive application of a 1D algorithm which computes said similarity measures between one dimensional input sequences of said input vectors and one dimensional stored sequences of said stored vectors wherein said input sequences are one dimensional parts of said input arrays wherein said stored sequences are one dimensional parts of said stored arrays.

2. Claim number 1 wherein said input sequence of said input vectors is defined as one dimensional input array denoted by 1DArray^{u} (i_{α}) wherein 1DArray^{u}(i_{α})={a^{u}ᵢ_{ₗ}_{. . . i}_{ₐ}_{. . . i}_{_{q}}|i_{α}=1 . . . k_{α}^{u}} is said one dimensional part of said input array [A]^{u} wherein 1≦α≦q;
wherein said stored sequence of said stored vectors is defined as one dimensional stored array denoted by 1DArray^{v}^{_{c}}^{C}(j_{β}) wherein 1DArray^{v}^{_{c}}^{C}(j_{β})=(j_{β})={m^{v}^{_{c}}^{C}ⱼ_{ₗ}_{. . . j}_{_{β}}_{. . . j}_{_{q}}|j_{β}=1 . . . l_{β}^{v}^{_{c}}^{C}} is said one dimensional part of said stored array [M]^{v}^{_{c}}^{C} wherein 1≦β≦q.

3. Claim number 2 wherein said 1D algorithm which computes 1D similarity measure S{1DArray^{u}(i_{α}), 1DArray^{v}^{_{c}}^{C}(j_{β})} between said input sequence 1DArray^{u}(i_{α}) and stored sequence 1DArray^{v}^{_{c}}^{C}(j_{β}) comprising:
(a) computing vector pair similarities Sᵥₚ(i_{α}, j_{β})=Fᵥₚ(aᵢ _{ₗ}_{. . . i}_{_{α}}_{. . . i}_{_{q}}^{u}, mⱼ_{ₗ}_{. . . j}_{_{β}}_{. . . j}_{_{q}}) between all said input vectors {a^{u}ᵢ_{ₗ}_{. . . i}_{_{α}}_{. . . i}_{_{q}}|i_{α}=1 . . . k_{α}^{u}} of said input sequence 1DArray^{u}(i_{α}) and all said stored vectors {m^{v}^{_{c}}^{C}ⱼ_{ₗ}_{. . . j}_{_{β}}_{. . . j}_{_{q}}_{. . . |j}_{β=1 . . . l}_{β}^{v}^{_{c}}^{C}} of said stored sequence 1DArray^{v}^{_{c}}^{C}(j_{β}) wherein similarity function Fᵥₚ(αᵢ_{ₗ}_{. . . i}_{_{α}}_{. . . i}_{_{q}}_{|i}_{α}=1 . . . k_{α}^{u}, mⱼ_{ₗ}_{. . . j}_{_{β}}_{. . . j}_{_{q}}^{v}^{_{c}}^{C}) is an inverse function of the multidimensional distance between said input vector αᵢ_{ₗ}_{. . . i}_{_{α}}_{. . . i}_{_{q}}^{u} and said stored vector mⱼ_{ₗ}_{. . . j}_{_{β}}_{. . . j}_{_{q}}^{v}^{_{c}}^{C} wherein said similarity function Fᵥₚ(αᵢ_{ₗ}_{. . . i}_{_{α}}_{. . . i}_{_{q}}^{u},mⱼ_{ₗ}_{. . . j}_{_{β}}_{. . . j}_{_{q}}^{v}^{_{c}}^{C}) increases when said multidimensional distance decreases, wherein said similarity function Fᵥₚ(αᵢ_{ₗ}_{. . . i}_{_{α}}_{. . . i}_{_{q}}^{u}, mⱼ_{ₗ}_{. . . j}_{_{β}}_{. . . j}_{_{q}}^{v}^{_{c}}^{C}) decreases when said multidimensional distance increases;
(b) defining a bipartite graph which represents said input sequence 1DArray^{u}(i_{α}) and said stored sequence 1DArray^{v}^{_{c}}^{c}(j_{β}) wherein said bipartite graph has two parts wherein the first part consists of input nodes wherein the second part consists of stored nodes wherein each of said input nodes {i_{α}} of said first part of said bipartite graph is attached to one of said input vectors {αᵢ_{ₗ}_{. . . i}_{_{α}}_{. . . i}_{_{q}}^{u}|i_{α}=1 . . . k_{α}^{u}} and wherein each of said stored nodes of said second part {j_{β}} of said bipartite graph is attached to one of said stored vectors {mⱼ_{ₗ}_{. . . j}_{_{β}}_{. . . j}_{_{q}}^{v}^{_{c}}^{C}|j_{β}=1 . . . l_{β}^{v}^{_{c}}^{C}} wherein each said input node of the first part has links to all said stored nodes {j_{β}} of the second part wherein each said link L(i_{α}, j_{β}) connects said input node i_{α} attached to said input vector αᵢ_{ₗ}_{. . . i}_{_{α}}_{. . . i}_{_{q}}^{u} with said stored node j_{β} attached to said stored vector mⱼ_{ₗ}_{. . . j}_{_{β}}_{. . . j}_{_{q}}^{v}^{_{c}}^{C} wherein each said link L(i_{α}, j_{β}) has a link weight which is equal to said vector pair similarity Sᵥₚ(i_{α}, j_{β})=Fᵥₚ(αᵢ_{ₗ}_{. . . i}_{_{α}}_{. . . i}_{_{q}}^{u},mⱼ_{ₗ}_{. . . j}_{_{β}}_{. . . j}_{_{q}}^{v}^{_{c}}^{C}) between said input vector αᵢ_{ₗ}_{. . . i}_{_{α}}_{. . . i}_{_{q}}^{u} and said stored vector mⱼ_{ₗ}_{. . . j}_{_{β}}_{. . . j}_{_{q}}^{v}^{_{c}}^{C} it connects;
(c) defining a sequential link set as a set of said links L(i_{α}, j_{β}) in said bipartite graph wherein all said links in said sequential link set fulfill a sequencing requirement wherein said sequencing requirement allows to include in said sequential link set only said links which have a mutual sequential relation wherein any two said links . . . L(i_{α}=η, j_{β}=ε) . . . L(iₐ=λ, j_{β}=δ) . . . with said mutual sequential relation must fulfill the following four conditions: (I) η≠λ (II) ε≠δ (III) if η<λ then ε<δ (IV) if η>λ then ε>δ;
(d) using a method of dynamic programming to compute the optimal-sequential said bipartite graph matching wherein said optimal-sequential said bipartite graph is defined as said bipartite graph with said sequential links set {L(i_{α}, j_{β})} wherein said sequential links set {L(i_{α}, j_{β})} has a total sum of said link weights which is the largest among all said sequential link sets possible in said bipartite graph;
(e) allocating new said link weights to all said links L(i_{α}, j_{β}) which have said link weights Sᵥₚ(i_{α}, j_{β}) smaller than a predetermined threshold link weight, wherein said new said link weight: SNᵥₚ(i_{α} j_{β})=FNᵥₚ(αᵢ_{ₗ}_{. . . i}_{_{α}}_{. . . i}_{_{q}}^{u},mⱼ_{ₗ}_{. . . j}_{_{β}}_{. . . j}_{_{q}}^{v}^{_{c}}^{C}≦0 is a predetermined penalty function FNᵥₚ(αᵢ_{ₗ}_{. . . i}_{_{α}}_{. . . i}_{_{q}}^{u},mⱼ_{ₗ}_{. . . j}_{_{β}}_{. . . j}_{_{q}}^{v}^{_{c}}^{C})≦0 of said input vectors αᵢ_{ₗ}_{. . . i}_{_{α}}_{. . . i}_{_{q}}^{u} and said stored vectors mⱼ_{ₗ}_{. . . j}_{_{β}}_{. . . j}_{_{q}}^{v}^{_{c}}^{C}
(f) said method of dynamic programming computes said optimal-sequential said bipartite graph matching by gradually increasing the size of said optimal-sequential said bipartite graph starting with defining an initial said bipartite graph by initiating an input nodes list I_{f}={i₁} wherein said list size: f=1, wherein said input nodes list denotes all said input nodes of said input part, wherein said second part of said bipartite graph has the full set of said stored nodes {j_{β}}, listing in each said stored node j_{β} said link L(i₁, j_{β}) and said link weight Sᵥₚ(i₁, j_{β});
(g) increasing said input nodes list by one I_{f}={i₁, i₂} wherein said list size: f=2 and constructing said optimal-sequential said bipartite graph G_{f} which have as said input nodes said input nodes list I_{f}={i₁, i₂} and as said stored nodes said full set of said stored nodes: {j_{β}}, finding said optimal-sequential bipartite graph with maximum two said links L(i₁, j_{φ}), L(i₂, j_{θ}) wherein said links are said sequential link set wherein said sequencing requirement is: φ<θ≦β wherein the two said links listed have maximal said total sum S_{f} of maximum two said link weights of said optimal-sequential said bipartite graph G_{f}, recording said maximal said total sum of said link weights S_{f};
(h) increasing said list size by one f=f+1; increasing said input nodes list by one I_{f}={i₁, i₂, . . . , i_{f}} wherein previous said node list was I_{f-1}={i₁, i₂, . . . , i_{f-1}} and constructing said optimal-sequential said bipartite graph G_{f} which has as said input nodes said input nodes list I_{f}={i₁, i₂, . . . , i_{f}} and as said stored nodes said full set of said stored nodes: {j_{β}} finding said sequential links set with g links wherein g≦f is a maximal number possible in said optimal-sequential bipartite graph G_{f} wherein said sequential link set includes maximal number of links possible in said optimal-sequential said bipartite graph G_{f} including said links with negative weights whenever positive ones are not available, wherein said links listed have the maximal said total sum of g said link weights S_{g} possible in said optimal-sequential said bipartite graph G_{f} wherein if a number n_{α} of said input nodes and a number n_{β} of said stored nodes do not have said links which can be included in said optimal-sequential said bipartite graph G_{f} then the total said sum of said links weights S_{f} for G_{f} is computed by: S_{f}=S_{g}−N_{w}(n_{α}+n_{β}) wherein N_{w} is a predetermined penalty weight constant;
(i) repeating step (h) if f<k_{α}^{u} otherwise if f=k_{α}^{u} ending the process wherein all said input nodes {i_{α}} have been included in said list of said input nodes;
(j) listing g≦k_{α}^{u} said links with the highest said total sum of said link weights S_{g} and recording said total sum of said link weights S_{f}, wherein S_{f} is equal to said optimal-sequential total similarity measure: S_{f}=S{1DArray^{u}(i_{α}), 1DArray^{v}^{_{c}}^{C}(β_{β})} between said input sequence 1DArray^{u}(i_{α}) and stored sequence 1DArray^{v}^{_{c}}^{C}(j_{β}).

4. Claim number 3 wherein said method of dynamic programming for computing said optimal-sequential said bipartite graph matching wherein said process initiating in step (f) starts by constructing said input node list starting with the last said input node iₖ_{^{α}}ᵤ and proceeds in reverse order ending at including in said list said input node i₁ when f=k_{α}^{u}.

5. Claim number 2 wherein said 1D algorithm computes said 1D similarity measure: S{1DArray^{u}(i_{α}|a₁, . . . , a_{α-1}, a_{α+1}, . . . , a_{q}), 1DArray^{v}^{_{c}}^{C}(j_{β}|b₁, . . . , b_{β-1}, b_{β+1}, . . . , b_{q})} between said input sequence: 1DArray^{u}(i_{α})=1DArray^{u}(i_{α}|a₁, . . . , a_{α-1}, a_{α+1}, . . . , a_{q})={a^{u}ᵢ_{_{l . . . i}}_{_{q}}|iₐ=1, 2, . . . , k_{α}^{u}; i₁=α₁, . . . , i_{α-1}=a_{α-1}, i_{α+1}=a_{α+1}, . . . , i_{q}=α_{q}} where a^{u}ᵢ_{_{l . . . i}}_{_{q}} is a p-dimensional said input vector, and said stored sequence: 1DArray^{v}^{_{c}}^{C}(j_{β}|b₁, . . . , β_{β-1}, b_{β+1}, . . . , b_{q})=1DArray^{v}^{_{c}}^{C}(j_{β})={mⱼ_{ₗ}_{. . . j}_{_{q}}^{v}^{_{c}}^{C}|j_{β}=1, 2, . . . , l_{β}^{v}^{_{c}}^{C}; j₂=b₂; . . . ; j_{β-1}=b_{β-1}; j_{β+1}=b_{β+1}; . . . ; j_{q}=b_{q};}
wherein mⱼ_{ₗ}_{. . . j}_{_{q}}^{v}^{_{c}}^{C} is a p-dimensional said stored vector,
wherein each said input sequence is said one dimensional part of said input array: [A]^{u}={α^{u}ᵢ_{ₗ}_{. . . i}_{_{q}}|iₗ=1, 2, . . . , k^{u}₁; i₂=1, 2, . . . , k₂^{u}; . . . ; i_{q}=1, 2, . . . , k_{q}^{u}}
each said stored sequence is said one dimensional part of said stored array: [M]^{v}^{_{c}}^{C}={mⱼ_{ₗ}_{. . . j}_{_{q}}^{v}^{_{c}}^{C}|j₁=1, 2, . . . , l₁^{v}^{_{c}}^{C}; j₂=1, 2, . . . , l₂^{v}^{_{c}}^{C}; j_{q}=1, 2, . . . , l_{q}^{v}^{_{c}}^{C}}
wherein said recursive application of said 1D algorithm yields said similarity measure: S{[A]^{u}, [M]^{v}^{_{c}}^{C}} between said input array [A]^{u} and said stored array [M]^{v}^{_{c}}^{C} wherein such said recursive application comprising:
(a) selecting said input sequence: 1DArray^{u}(i₁)=1DArray^{u}(iₗ|a₂, . . . , a_{q})={a^{u}ᵢ_{_{l . . . i}}_{q|=1, 2}, . . . , k₁^{u}; i₂=a₂, . . . , i_{q}=a_{q}} wherein {|i₁=1, 2, . . . , k₁^{u}; 1≦a₂≦k₂^{u}; . . . ; 1≦a_{q}≦k_{q}^{u}}
and selecting said stored sequence: 1DArray^{v}^{_{c}}^{C}(j₁)=1DArray^{v}^{_{c}}^{C}(j₁|b₂, . . . , b_{q})={mⱼ_{_{l . . . j}}_{_{q}}^{v}^{_{c}}^{C}|j₁=1, 2, . . . , l₁^{v}^{_{c}}^{C}; j₂=b₂; . . . ; j_{q}=b_{q}}
wherein {|j₁=1, 2, . . . , l₁^{v}^{_{c}}^{C}; 1≦b₂≦l₂^{v}^{_{c}}^{C}; . . . ; 1≦b_{q}≦l_{q}^{v}^{_{c}}^{C}}
predetermining a range constants: 0≦range_{y}^{v}^{_{c}}^{C}≦l_{y}^{v}^{_{c}}^{C};y=1 . . . q;v_{c}=1 . . . V_{c};c=1 . . . C;
(b) applying said 1D algorithm to compute said 1D similarity measure between selected said: input sequence: 1 DArray^{u}(i₁|a₂, . . . , a_{q}) and said stored sequence 1DArray^{v}^{_{c}}^{C} (j₁|b₂, . . . , b_{q}) wherein said 1D algorithm is applied for all values of a₂, . . . , a_{q} wherein 1≦a₂≦k₂^{u}; . . . ; 1≦a_{q}≦k_{q}^{u};
wherein each application of said 1D algorithm for one said value of a₂, . . . , a_{q} said 1D algorithm is repeated for all values of b₂, . . . , b_{q} wherein {|j₁=1, 2, . . . lₗ^{v}^{_{c}}^{C}; a₂−range₂^{v}^{_{c}}^{C}≦b₂≦a₂+range₂^{v}^{_{c}}^{C}; . . . ;a_{q}−range_{q}^{v}^{_{c}}^{C}≦b_{q}≦a_{q}+range_{q}^{v}^{_{c}}^{C}}
wherein applying said 1D algorithm computes a product of) {|(k₂^{u})(k₃^{u}) . . . (k_{q}^{u})(1+2range₂^{v}^{_{c}}^{C}) . . . (1+2range_{q}^{v}^{_{c}}^{C})}
said 1D similarity measures
(c) arranging said product of (k₂^{u})·(k₃^{u}) . . . (k_{q}^{u})·(l₂^{v}^{_{c}}^{C})·(l₃^{v}^{_{c}}^{C}) . . . (l_{q}^{v}^{_{c}}^{C}) said 1D similarity measures in an input similarity array [I]_{q-1}^{uv}_{c}^{C} of q−1 dimensions with a total of (k₂^{u})·(k₃^{u}) . . . (k_{q}^{u}) input similarity vectors w^{uv}^{_{c}}^{C}ᵢ_{₂}_{. . . i}_{_{q}}: [I]_{q-1}^{uv}^{_{c}}^{C}={w^{uv}^{_{c}}^{C}ᵢ_{₂}_{. . . i}_{_{q}}|i₂=1, 2, . . . , k₂^{u}; i₃=1, 2, . . . . , k₃^{u}; . . . ; i_{q}1, 2, . . . , k_{q}^{u}} wherein each row along dimension x of said input similarity array has kₓ^{u} said input similarity vectors wherein each said input similarity vector has (l₂^{v}^{_{c}}^{C})·(l₃^{v}^{_{c}}^{C}) . . . (l_{q}^{v}^{_{c}}^{C}) input similarity components:
$${\underline{{w}^{{uv}_{c} c}}}_{{a}_{2} … {a}_{q}} = [ S \{ 1 {DArray}^{u} ( {i}_{1} \vert {a}_{2} , {a}_{3} , … , {a}_{q} ) , 1 {DArray}^{{v}_{c} c} ( {j}_{1} \vert {b}_{2} = 1 , {b}_{3} = 1 , … , {b}_{q} = 1 ) \} ] , [ S \{ 1 {DArray}^{u} ( {i}_{1} \vert {a}_{2} , {a}_{3} , … , {a}_{q} ) , 1 {DArray}^{{v}_{c} c} ( {j}_{1} \vert {b}_{2} = 2 , {b}_{3} = 1 , … , {b}_{q} = 1 ) \} ] , … , [ S \{ 1 {DArray}^{u} ( {i}_{1} \vert {a}_{2} , {a}_{3} , … , {a}_{q} ) , 1 {DArray}^{{v}_{c} c} ( {j}_{1} \vert {b}_{2} = {l}_{2}^{{v}_{c} c} , {b}_{3} = 1 , … , {b}_{q} = 1 ) ] , [ S \{ 1 {DArray}^{u} ( {i}_{1} \vert {a}_{2} , {a}_{3} , … , {a}_{q} ) , 1 {DArray}^{{v}_{c} c} ( {j}_{1} \vert {b}_{2} = 1 , {b}_{3} = 2 , … , {b}_{q} = 1 ) \} ] , … , [ S \{ 1 {DArray}^{u} ( {i}_{1} \vert {a}_{2} , {a}_{3} , … , {a}_{q} ) , 1 {DArray}^{{v}_{c} c} ( {j}_{1} \vert {b}_{2} = {l}_{2}^{{v}_{c} c} , {b}_{3} = 2 , … , {b}_{q} = 1 ) \} ] , … , [ S \{ 1 {DArray}^{u} ( {i}_{1} \vert {a}_{2} , {a}_{3} , … , {a}_{q} ) , 1 {DArray}^{{v}_{c} c} ( {j}_{1} \vert {b}_{2} = {l}_{2}^{{v}_{c} c} , {b}_{3} = {l}_{3}^{{v}_{c} c} , … , {b}_{q} = {l}_{q}^{{v}_{c} c} ) \} ]$$
for a₂=1, 2, . . . , k₂^{u}; a₃=1, 2, . . . , k₃^{u}; . . . ; a_{q}=1, 2, . . . , k_{q}^{u};
(d) a similarity array algorithm that computes similarity measures between input similarity arrays and stored similarity arrays comprising:
(e) initiating iteration number to zero: ξ=0
(f) incrementing iteration number by one ξ=ξ+1, computing said similarity measure between said input similarity array [I]_{q-ξ}^{u} and stored similarity array [B]_{q-ξ}^{v}^{_{c}}^{C} by the following steps:
(g) selecting a link weight sequence: 1DLink^{uv}^{_{c}}^{C}(α_{ξ+1}|a_{ξ+2}, . . . , a_{q})={d^{u}_{ξ+1}_{. . . i}_{_{q}}|i_{ξ+1}=1, 2, . . . , k_{ξ+1}^{u}; i_{ξ+2}+a_{ξ+2}, . . . i_{q}=a_{q}}1DSArray^{u}(i_{ξ+1}|a_{ξ+2}, . . . , a_{q})={d^{u}ᵢ_{_{ξ+1}}_{. . . i}_{_{q}}|i_{ξ+1}=1, 2, . . . . , k_{ξ+1}^{u}; i_{ξ+2}=a_{ξ+2}, . . . , i_{q}=a_{q}}
and selecting said stored similarity sequence: 1DSArray^{v}^{_{c}}^{C}(j_{ξ+1}|b_{ξ+2}, . . . b_{q})={eⱼ_{_{ξ+1}}_{. . . j}_{_{q}}^{v}^{_{c}}^{C}|j_{ξ+1=1, 2, . . . , l}_{ξ+1}^{v}^{_{c}}^{C}; j_{ξ+2}=b_{ξ+2}; . . . ; j_{q}=b_{q}}
(h) applying said 1D algorithm to compute said 1D similarity measure S{1DSArray^{u}(i_{ξ+1}|a_{ξ+2}, . . . , a_{q}), 1DSArray^{v}^{_{c}}^{C}(j_{ξ+1}|b_{ξ+2}, . . . , b_{q})}
between selected said input similarity sequence: 1DSArray^{u}(i_{ξ+1}|a_{ξ+2}, . . . , a_{q}) and said stored similarity sequence 1DSArray^{v}^{_{c}}^{C}(j_{ξ+1}|b_{ξ+2}, . . . , b_{q})
wherein said 1D algorithm is applied for all values of a_{ξ+2}, . . . , a_{q} wherein 1≦a_{ξ+2}≦k_{ξ+2}^{u}; . . . ; 1≦a_{q}≦k_{q}^{u};
and for all values of b_{ξ+2}, . . . , b_{q} wherein 1≦b_{ξ+2}≦l_{ξ+2}^{v}^{_{c}}^{C}; . . . ; 1≦b_{q}≦l_{q}^{v}^{_{c}}^{C};
wherein applying said 1D algorithm computes product of k_{ξ+2}^{u}·k_{ξ+3}^{u} . . . k_{q}^{u}·l_{ξ+2}^{v}^{_{c}}^{C}·l_{ξ+2}^{v}^{_{c}}^{C} . . . l_{q}^{v}^{_{c}}^{C} said 1D similarity measures;
(i) arranging said product of k_{ξ+2}^{u}·k_{ξ+3}^{u} . . . k_{q}^{u}·l_{ξ+2}^{v}^{_{c}}^{C}·l_{ξ+3}^{v}^{_{c}}^{C} . . . l_{q}^{v}^{_{c}}^{C} 1D similarity measures in an input similarity array of [I]_{q-ξ-1}^{u} of q−ξ−1 dimensions with a total of k_{ξ+2}^{u}·k_{ξ+3}^{u} . . . k_{q}^{u} input similarity vectors
wherein each row along dimension x of said input similarity array has kₓ^{u} said input similarity
vectors wherein each said input similarity vector has l_{ξ+2}^{v}^{_{c}}^{C}·l_{ξ+3}^{v}^{_{c}}^{C} . . . l_{β}^{v}^{_{c}}^{C} input similarity components;
(j) arranging k_{ξ+2}^{u}·k_{ξ+3}^{u} . . . k_{q}^{u}·l_{ξ+2}^{v}^{_{c}}^{C}·l_{ξ+3}^{v}^{_{c}}^{C} . . . l_{q}^{v}^{_{c}}^{C} 1D similarity measures in a stored similarity array [B]_{q-ξ-1}^{v}^{_{c}}^{c}, of q−ξ−1 dimensions with a total of l_{ξ+2}^{v}^{_{c}}^{C}·l_{ξ+3}^{v}^{_{c}}^{C} . . . l_{q}^{v}^{_{c}}^{C} stored similarity vectors wherein each row along dimension x of said stored similarity array has lₓ^{v}^{_{c}}^{C} said stored similarity
vectors wherein each said stored similarity vector has k_{ξ+2}^{u}·k_{ξ+3}^{u} . . . k_{q}^{u} stored similarity components;
(k) each said input similarity vector at location a_{ξ+2}, . . . , a_{q} in said input similarity array has input similarity components which represent all said 1D similarity measures S{1DSArray^{u}(i_{ξ+1}|a_{ξ+2}, . . . , a_{q}), 1DSArray^{v}^{_{c}}^{C}(j_{ξ+1}|b_{ξ+2}, . . . , b_{q})}
wherein {|1≦b_{ξ+2}≦l_{ξ+2}^{v}^{_{c}}^{C}; . . . , 1≦b_{q}≦l_{q}^{v}^{_{c}}^{C}};
(l) each said stored similarity vector at location b_{ξ+2}, . . . b_{q} in said stored similarity array has stored similarity components which represent all said 1D similarity measures S{1DSArray^{u}(i_{ξ+1}|a_{ξ+2}, . . . , a_{q}), 1DSArray^{v}^{_{c}}^{c}(j_{ξ+1}|b_{ξ+2}, . . . b_{q})}
wherein {|1≦a_{ξ+2}≦k_{ξ+2}^{u}; . . . ; 1≦a_{q}≦k_{q}^{u}};
(m) checking if ξ<q−1 then going back to step (f), otherwise, ending said recursive application of said 1D algorithm, defining said similarity measure: S{[A]^{u},[M]^{v}^{_{c}}^{c}} between said input array [A]^{u} and said stored array [M]^{v}^{_{c}}^{C}
as said 1D similarity measure
which is equal for ξ=q−1 to:
S{1DSArray^{u}(i_{ξ+1}|a_{ξ+2}, . . . , a_{q}), 1DSArray^{v}^{_{c}}^{C}(j_{ξ+1}|b_{ξ+2}, . . . b_{q})}=S{1DSArray^{u}(i_{q}), 1DSArray^{v}^{_{C}}^{c} (j_{q})}

6. Claim number 5 wherein constructing an indexing method for efficient detection of the largest said similarity measures
{S{[A]^{u}, [M^{v}^{_{c}}^{C}]}} between said input array [A]^{u} and said stored arrays {[M]^{v}^{_{c}}^{c}} wherein: [A]^{u}={a^{u}ᵢ_{ₗ}_{. . . i}_{_{q}}|i₁=1, 2, . . . , k₁^{u}; 1, 2, . . . , k₂^{u}; . . . ; i_{q}=1, 2, . . . , k_{q}^{u}} and {[M]^{v}^{_{c}}^{c}}={{mᵢ_{ₗ}_{. . . i}_{_{q}}|i₁=1, 2, . . . , l₁^{v}^{_{c}}^{C}; i₂=1, 2, . . . , l₂^{v}^{_{c}}^{C}; . . . ; i_{q}=1, 2, . . . , l_{q}^{v}^{_{c}}^{C}}}
(a) for a predetermined said input pattern number u all said input vectors aᵢ_{ₗ}_{. . . i}_{_{q}}^{u} are indexed into a p dimensional data structure Δₚ which stores all said stored vectors mⱼ_{ₗ}_{. . . j}_{_{q}}^{v}^{_{c}}^{C} of said stored arrays {[M]^{v}^{_{c}}^{C}} of wherein both said input vectors aᵢ_{ₗ}_{. . . j}_{_{q}}^{u} and said stored vectors mⱼ_{ₗ}_{. . . j}_{_{q}}^{v}^{_{c}}^{C} are p dimensional;
(b) for each one of said input vectors aᵢ_{ₗ}_{. . . i}_{_{q}}^{u} which is indexed into said data structure Δₚ all said stored vectors mⱼ_{ₗ}_{. . . j}_{_{q}}^{v}^{_{c}}^{C} which are within a predetermined Euclidean distance dₘₐₓ: d{aᵢ_{ₗ}_{. . . i}_{_{q}}^{u}, mⱼ_{ₗ}_{. . . j}_{_{q}}^{v}^{_{c}}^{C}}≦dₘₐₓ are retrieved
(c) all said retrieved stored vectors are separated into their original said stored arrays: {[M]^{v}^{_{c}}^{C}}
(d) a predetermined selection function yields selection scores to each of said stored arrays said selection function is dependent on the number of retrieved said stored vectors mⱼ_{ₗ}_{. . . j}_{_{q}}^{v}^{_{c}}^{C} which belong to each said stored array, their Euclidean distances d{aⱼ_{ₗ}_{. . . i}_{_{q}}^{u}, mⱼ_{ₗ}_{. . . j}_{_{q}}^{v}^{_{c}}^{C}} from their indexing said input vectors and the sum of indices differences between their said indexing input vectors and said retrieved said stored vectors:
Σ [(iₗ−j₁)²+ . . . +(i_{q}−j_{q})²]^{1/2}
(e) said a predetermined number of stored arrays [M^{v}^{_{c}}^{C}] with the highest said selection scores are selected for further computations of said similarity measures: {S{[A]^{u},[M^{v}^{_{c}}^{C}]}};
(f) computing said similarity measures {S{[A]^{u},[M^{v}^{_{c}}^{C}]}} of [A]^{u} with each said selected stored arrays [M^{v}^{_{c}}^{C}];
(g) selecting said stored array [M^{v}^{_{c}}^{C}] with the highest said similarity measure as the most similar to said input array [A]^{u} and said input array can be classified into the same class c of the selected said stored array [M^{v}^{_{c}}^{C}] if said similarity measure is larger than a predetermined similarity threshold value.

7. Claim number 3 wherein said 1D algorithm computes 1D similarity measure:
S{1DArray^{u}(i_{α}|a₁, . . . , a_{α-1}, a_{α+1}, . . . , a_{q}), 1DArray^{v}^{_{c}}^{C}(j_{β}|b₁, . . . , b_{β-1}, b_{β+1}, . . . , b_{q})} between said input sequence:
1DArray^{u}(i_{α}|a₁, . . . , a_{α-1}, aₐ₊₁, . . . , a_{w})={a^{u}ᵢ_{ₗ}_{. . . i}_{_{q}}|i_{α}=1, 2, . . . , k_{α}^{u}; iₗ=a₁, . . . , i_{α-1}=a_{α-1}, i_{α+1}=a_{α+1}, . . . , i_{q}=a_{q}} and said stored sequence:
1DArray^{v}^{_{c}}^{C}(j_{β}|b₁, . . . , b_{β-1}, b_{β+1}, . . . b_{q})={mⱼ_{ₗ}_{. . . j}_{_{q}}^{v}^{_{c}}^{C}|j_{β}=1, 2, . . . l_{β}^{v}^{_{c}}^{C}; j₂=b₂; . . . ; j_{β-1}=b_{β-1}; j_{β+1}=b_{β+1}; . . . ; j_{q}=b_{q};}
each said input sequence is an one dimensional part of said input array: [A]^{u}={aᵢ_{ₗ}_{. . . i}_{_{q}}^{u}|iₗ=1, 2, . . . , k₁^{u}; i₂=1, 2, . . . , k₂^{u}; . . . ; i_{q}=1, 2, . . . , k_{q}^{u}}
each said stored sequence is an one dimensional part of said stored array: [M]^{v}^{_{c}}^{c}={mⱼ_{ₗ}_{. . . j}_{_{q}}^{v}^{_{c}}^{C}|j₁=1, 2, . . . , l₂^{v}^{_{c}}^{C}; . . . ; j_{q}=1, 2, . . . l^{v}^{_{c}}^{C}}
wherein said recursive application of said 1D algorithm yields said similarity measure: S{[A]^{u}, [M]^{v}^{_{c}}^{C}} between said input array [A]^{u} and said stored array [M]^{v}^{_{c}}^{C} wherein such said recursive application comprising:
(a) selecting said input sequence: 1DArray^{u}(i₁|a₂, . . . , a_{q})={aᵢ_{ₗ}_{. . . i}_{_{q}}^{u}|i₁=1, 2, . . . , k₁^{u}; i₂=a₂, . . . , i_{q}=a_{q}} wherein {|i₁=1, 2, . . . , k₁^{u}; 1≦a₂≦k₂^{u}; . . . ; 1≦a_{q}≦k_{q}^{u}}
and selecting said stored sequence:
1DArray^{v}^{_{c}}^{C}(j₁|b₂, . . . , b_{q})={mⱼ_{ₗ}_{. . . j}_{_{q}}^{v}^{_{c}}^{C}|j₁=1, 2, . . . , l_{q}^{v}^{_{c}}^{C}; j₂=b₂; . . . ; j_{q}=b_{q}}
wherein {|j₁=1, 2, . . . , lₗ^{v}^{_{c}}^{C}; 1≦b₂≦l₂^{v}^{_{c}}^{C}; . . . ; 1≦b_{q}≦l_{q}^{v}^{_{c}}^{C}}
(b) applying said 1D algorithm to compute said 1D similarity measure between selected said input sequence: 1DArray^{u}(i₁|a₂, . . . , a_{q}) and said stored sequence
1DArray^{v}^{_{c}}^{C}(j₁|b₂, . . . , b_{q})
wherein said 1D algorithm is applied for all values of a₂, . . . , a_{q} wherein
1≦a₂≦k₂^{u}; . . . ; 1≦a_{q}≦k_{q}^{u};
and for all values of b₂, . . . , b_{q}
Wherein 1≦b₂≦l₂^{v}^{_{c}}^{C}; . . . ; 1≦b_{q}≦l_{q}^{v}^{_{c}}^{C};
wherein applying said 1D algorithm computes a k₂^{u}·k₃^{u} . . . k_{q}^{u}·l₂^{v}^{_{c}}^{C}·l₃^{v}^{_{c}}^{C} . . . l_{q}^{v}^{_{c}}^{C}
product of said 1D similarity measures
(c) arranging said k₂^{u}·k₃^{u} . . . k_{q}^{u}·l₂^{v}^{_{c}}^{C}·l₃^{v}^{_{c}}^{C} . . . l_{q}^{v}^{_{c}}^{C} product of said 1D similarity measures in an input similarity array [I]_{q-1}^{u} of q−1 dimensions with a total of k₂^{u}·k₃^{u} . . . k_{q}^{u} input similarity vectors
wherein each row along dimension x of said input similarity array has kₓ^{u} said input similarity vectors wherein each said input similarity vector has l₂^{v}^{_{c}}^{C}·l₃^{v}^{_{c}}^{C} . . . l_{q}^{v}^{_{c}}^{C} input similarity components;
(d) arranging said k₂^{u}·k₃^{u} . . . k_{q}^{u}·l₂^{v}^{_{c}}^{C}·l₃^{v}^{_{c}}^{C} . . . l_{q}^{v}^{_{c}}^{C} product of said 1D similarity measures in a stored similarity array [B]_{q-1}^{v}^{_{c}}^{C} of q−1 dimensions with a total of l₂^{v}^{_{c}}^{C}·l₃^{v}^{_{c}}^{C} . . . l_{q}^{v}^{_{c}}^{C} stored similarity vectors
wherein each row along dimension x of said stored similarity array has lₓ^{v}^{_{c}}^{C} said stored similarity
vectors wherein each said stored similarity vector has k₂^{u}·k₃^{u} . . . k_{q}^{u} stored similarity components;
(e) wherein each said input similarity vector dₐ_{₂}_{. . . a}_{_{q}}^{u} at location a₂, . . . , a_{q} in said input similarity array [I]_{q-1}^{u} has l₃^{v}^{_{c}}^{C}·l₃^{v}^{_{c}}^{C} . . . l_{q}^{v}^{_{c}}^{C} product of said input similarity components which are equal to said 1D similarity measures:
S{1DArray^{u}(i₁|a₂, . . . , a_{q}), 1DArray^{v}^{_{c}}^{C}(j₁|b₂, . . . , b_{q})}
wherein {|1≦b₂≦l₂^{v}^{_{c}}^{C}; . . . ; 1≦b_{q}≦l_{q}^{v}^{_{c}}^{C}};
(f) wherein each said stored similarity vector e_{b}_{₂}_{. . . b}_{_{q}}^{v}^{_{c}}^{C} at location b₂, . . . , b_{q} in said stored similarity array [B]_{q-1}^{v}^{_{c}}^{C} has k₂^{u}·k₃^{u} . . . k_{q}^{u} product of said stored similarity components which are equal to said 1D similarity measures: S{1DArray^{u}(iₗ|a₂, . . . , a_{q}), 1DArray^{v}^{_{c}}^{C}(j₁|b₂, . . . , b_{q})}
wherein {|1≦a₂≦k₂^{u}; . . . ; 1≦a_{q}≦k_{q}^{u}};
(g) initiating iteration number to zero: ξ=0
(h) incrementing iteration number by one ξ=ξ+1, computing said similarity measure between said input similarity array [I]_{q-ξ}^{u} and stored similarity array [B]_{q-ξ}^{v}^{_{c}}^{C} by the following steps:
(i) selecting said input similarity sequence: 1DSArray^{u}(i_{ξ+1}|a_{ξ+2}, . . . , a_{q})={d^{u}ᵢ_{_{ξ+1}}_{. . . i}_{_{q}}|i_{ξ+1}=1, 2, . . . , k_{ξ+1}^{u}; i_{ξ+2}=a_{ξ+2}, . . . , i_{q}=a_{q}}
and selecting said stored similarity sequence: 1DSArray^{v}^{_{c}}^{C}(j_{ξ+1}|b_{ξ+2}, . . . , b_{q})={eⱼ _{_{ξ+1}}_{. . . j}_{_{q}}^{C}|j_{ξ+1}=1, 2, . . . , l_{ξ+1}^{v}^{_{c}}^{C}; j_{ξ+2}=b_{ξ+2}; . . . ; j_{q}=b_{q}}
(j) applying said 1D algorithm to compute said 1D similarity measure S{1DSArray^{u}(i_{ξ+1}|a_{ξ+2}, . . . , a_{q}), 1DSArray^{v}^{_{c}}^{C}(j_{ξ+1}|b_{ξ+2}, . . . , b_{q})}
between selected said input similarity sequence: 1DSArray^{u}(i_{ξ+1}|aξ+2, . . . , a_{q}) and said stored similarity sequence 1DSArray^{v}^{_{c}}^{C}(j_{ξ+1}|b_{ξ+2}, . . . , b_{q})
wherein said 1D algorithm is applied for all values of a_{ξ+2}, . . . , a_{q} wherein 1≦a_{ξ+2}≦k_{ξ+2}^{u}; . . . ; 1≦a_{q}≦k_{q}^{u};
and for all values of b_{ξ+2}, . . . , b_{q} wherein 1≦b_{ξ+2}≦l_{ξ+2}^{v}^{_{c}}^{C}; . . . ; 1≦b_{q}≦l_{q}^{v}^{_{c}}^{C};
wherein applying said 1D algorithm computes product of k_{ξ+2}^{u}·k_{ξ+3}^{u} . . . k_{q}^{u}·l_{ξ+2}^{v}^{_{c}}^{C}·l_{ξ+3}^{v}^{_{c}}^{C} . . . l_{q}^{v}^{_{c}}^{C} said 1D similarity measures;
(k) arranging said product of k_{ξ+2}^{u}·k_{ξ+3}^{u} . . . k_{q}^{u}·l_{ξ+2}^{v}^{_{c}}^{C}·l_{ξ+3}^{v}^{_{c}}^{C} . . . l_{q}^{v}^{_{c}}^{C} 1D similarity measures in an input similarity array [I]_{q-ξ-1}^{u} of q−ξ−1 dimensions with a total of k_{ξ+2}^{u}·k_{ξ+3}^{u} . . . k_{q}^{u} input similarity vectors
wherein each row along dimension x of said input similarity array has kₓ^{u} said input similarity
vectors wherein each said input similarity vector has l_{ξ+2}^{v}^{_{c}}^{C}·l_{ξ+3}^{v}^{_{c}}^{C} . . . l_{q}^{v}^{_{c}}^{C} input similarity components;
(l) arranging k_{ξ+2}^{u}·k_{ξ+3}^{u} . . . k_{q}^{u}·l_{ξ+2}^{v}^{_{c}}^{C}·l_{ξ+3}^{v}^{_{c}}^{C} . . . l_{q}^{v}^{_{c}}^{C} 1D similarity measures in a stored similarity array [B]_{q-ξ-}^{v}^{_{c}}^{C} of q−ξ−1 dimensions with a total of l_{ξ+2}^{v}^{_{c}}^{C}·l_{ξ+3}^{v}^{_{c}}^{C} . . . l_{q}^{v}^{_{c}}^{C} stored similarity vectors wherein each row along dimension x of said stored similarity array has lₓ^{v}^{_{c}}^{C} said stored similarity
vectors wherein each said stored similarity vector has k_{ξ+2}^{u}·k_{ξ+3}^{u} . . . k_{q}^{u} stored similarity components;
(m) each said input similarity vector at location a_{ξ+2}, . . . , q^{q} in said input similarity array has input similarity components which represent all said 1D similarity measures S{1DSArray^{u}(i_{ξ+1}|a_{ξ+2}, . . . , a_{q}), 1DSArray^{v}^{_{c}}^{C}(j_{ξ+1}|b_{ξ+2}, . . . , b_{q})}
wherein {|1≦b_{ξ+2}≦l_{ξ+2}^{v}^{_{c}}^{C}; . . . ; 1≦b_{q}≦l_{q}^{v}^{_{c}}^{C}};
(n) each said stored similarity vector at location b_{ξ+2}, . . . , b_{q} in said stored similarity array has stored similarity components which represent all said 1D similarity measures S{1DSArray^{u}(i_{ξ+1}|a_{ξ+2}, . . . , a_{q}), 1DSArray^{v}^{_{c}}^{C}(j_{ξ+2}, . . . , b_{q})}
wherein {|1≦a_{ξ+2}≦k_{ξ+2}^{u}; . . . ; 1≦a_{q}≦k_{q}^{u}};
(o) checking if ξ<q−1 then going back to step (h), otherwise, ending said recursive application of said 1D algorithm, defining said similarity measure: S{[A]^{u},[M]^{v}^{_{c}}^{C}} between said input array [A]^{u} and said stored array [M]^{v}^{_{c}}^{C}
as said 1D similarity measure
which is equal for ξ=q−1 to: S{1DSArray^{u}(i_{ξ+1}|a_{ξ+2}, . . . , a_{q}), 1DSArray^{v}^{_{c}}^{C}(j_{ξ+1}|b_{ξ+2}, . . . , b_{q})}=S{1DSArray^{u}(i_{q}), 1DSArray^{v}^{_{c}}^{C}(j_{q})}

8. Claim number 7 wherein constructing an indexing method for efficient detection of the largest said similarity measures
{S{[A]^{u}, [M^{v}^{C}]}} between said input array [A]^{u} and said stored arrays {[M]^{v}^{_{c}}^{C}} wherein: [A]^{u}={a^{u}ᵢ_{ₗ}_{. . . i}_{_{q}}|i₁=1, 2, . . . , k₁^{u}; i₂1, 2, . . . , k₂^{u}; . . . ; i_{q}=1, 2, . . . , k_{q}^{u}} and {[M]^{v}^{_{c}}^{C}}={{mᵢ_{ₗ}_{. . . i}_{_{q}}^{u}|i₁=1, 2, . . . , l₁^{v}^{_{c}}^{C}; i₂=1, 2, . . . , l₂^{v}^{_{c}}^{C}; . . . ; i_{q}=1, 2, . . . , l_{q}^{v}^{_{c}}^{C}}}
(a) for a predetermined said input pattern number u all said input vectors aᵢ_{ₗ}_{. . . i}_{_{q}}^{u} are indexed into a p dimensional data structure Δₚ which stores all said stored vectors mⱼ_{ₗ}_{. . . j}_{_{q}}^{v}^{_{c}}^{C} of said stored arrays {[M]^{v}^{_{c}}^{C}} wherein both said input vectors aᵢ_{ₗ}_{. . . i}_{_{q}}^{u} and said stored vectors mⱼ_{ₗ}_{. . . j}_{_{q}}^{v}^{_{c}}^{C} are p dimensional;
(b) for each one of said input vectors aᵢ_{ₗ}_{. . . i}_{_{q}}^{u} which is indexed into said data structure Δₚ all said stored vectors mⱼ_{ₗ}_{. . . j}_{_{q}}^{v}^{_{c}}^{C} which are within a predetermined Euclidean distance dₘₐₓ: d{aᵢ_{ₗ}_{. . . i}_{_{q}}^{u}, mⱼ_{ₗ}_{. . . j}_{_{q}}^{v}^{_{c}}^{C}}≦dₘₐₓ are retrieved
(c) all said retrieved stored vectors are separated into their original said stored arrays: {[M]^{v}^{_{c}}^{C}}
(d) a predetermined selection function yields selection scores to each of said stored arrays said selection function is dependent on the number of retrieved said stored vectors mⱼ_{ₗ}_{. . . j}_{_{q}}^{v}^{_{c}}^{C} which belong to each said stored array, their Euclidean distances d{aᵢ_{ₗ}_{. . . i}_{_{q}}^{u}, mⱼ_{ₗ}_{. . . j}_{_{q}}^{v}^{_{c}}^{C}} from their indexing said input vectors and the sum of indices differences between their said indexing input vectors and said retrieved said stored vectors:
Σ[(iₗ−j₁)²+ . . . +(i_{q}−j_{q})²]^{1/2};
(e) said a predetermined number of stored arrays [M^{v}^{_{c}}^{C}] with the highest said selection scores are selected for further computations of said similarity measures: {S{[A]^{u},[M^{v}^{_{c}}^{C}]}}
(f) computing said similarity measures {S{[A]^{u},[M^{v}^{_{c}}^{C}]}} of [A]^{u} with each said selected stored arrays [M^{v}^{_{c}}^{C}];
(g) selecting said stored array [M]^{_{c}}^{C} with the highest said similarity measure as the most similar to said input array [A]^{u} and said input array can be classified into the same class c of the selected said stored array [M]^{v}^{_{c}}^{C} if said similarity measure is larger than a predetermined similarity threshold value.

9. A method implemented by a computer for the computation of similarity measures between segments of input patterns and stored patterns wherein both said input patterns and said stored patterns are derived from data collected from speech or one dimensional signals, wherein said input patterns are represented by input arrays of input vectors wherein said input arrays have one dimension wherein input vectors have at least one dimension, wherein said stored patterns are represented by stored arrays of stored vectors wherein said stored arrays have one dimension wherein said stored vectors have at least one dimension, wherein said input array is denoted by [A]^{u} wherein [A]^{u}={a^{u}ᵢ_{ₗ}|i₁=1, 2, . . . , k₁^{u}} wherein u denotes the serial number of said input array, wherein aᵢ_{ₗ}^{u} denotes said input vectors wherein iₗ denote the vectors indices which denote the serial numbers of said input vectors within said input array, wherein k₁^{u} denotes the total number of said input vectors within said input array wherein each said stored array is denoted by [M]^{v}^{_{c}}^{C} wherein the set of said stored arrays is denoted by
{[M]^{v}^{_{c}}^{C}}={{mⱼ_{₁}^{v}^{_{c}}^{C}|j₁=1, 2, . . . , lₗ^{v}^{_{c}}^{C}}} wherein c denotes the class of said stored array [M]^{v}^{_{c}}^{C} wherein c=1 . . . C; wherein C denotes the total number of said classes wherein v_{c}=1, . . . , V_{c}; denotes the serial number of said stored array [M]^{v}^{_{c}}^{C}
within said class c wherein total number of stored arrays within said class c is V_{c} wherein mⱼ_{ₗ}^{v}^{_{c}}^{C} denotes said stored vectors of said stored array [M]^{v}^{_{c}}^{C} wherein j₁ denote the indices of said stored vectors which denote the serial numbers of said stored vectors within said stored array, wherein lₗ^{v}^{_{c}}^{C} denote the total number of said stored vectors within said stored array
for each said class c, dividing said input array [A]^{u} into input array partially overlapping segments: [A(r)]_{c}^{u} wherein r is said segment's serial number, wherein all said segments lengths is equal to the average length of said stored arrays [M]^{v}^{_{c}}^{C} of said class c, wherein said 1D algorithm is used to compute said similarity measures {S{[A(r)]_{c}^{u},[M^{v}^{_{c}}^{C}]}} of all said segments [A(r)]_{c}^{u} with said stored arrays [M]^{v} ^{_{c}}^{C} said segments [A(r)]_{c}^{u} which have said similarity measure which is greater than a predetermined similarity threshold, are classified as members of class c.

10. Claim number 9 wherein executing 1D algorithm for the computations of similarity measures: {S{[A(r)]_{c}^{u}, [M]^{v}^{_{c}}^{C}}} between said input array segment [A(r)]_{c}^{u} and said stored array [M]^{v}^{_{c}}^{C}, comprising:
(a) dividing the total length k₁^{u} of said input array [A]^{u} into partially overlapping length segments of lengths: L_{c} wherein said length segments: L_{c}^{u}(r)=[(r−1)δ+1, (r−1)δ+2, . . . , (r−1)δ+1+L_{c}] wherein the overlap: δ=┌φL_{c}┐ is the lowest integer which is greater or equal to a predetermined fraction φ of said segment length L_{c} wherein total number of partially overlapping said length segments is: r_{c}^{u}=└(k₁^{u}−L_{c})/δ+1┘; wherein r_{c}^{u} is the largest integer smaller or equal to (k₁^{u}−L_{c})/δ+1;
(b) setting r=0;
(c) incrementing r: r [symbol] r+1, dividing said input array [A]^{u} into said input array partially overlapping array segments: [A(r)]_{c}^{u} wherein [A(r)]_{c}^{u}={aᵢ_{ₗ}^{u}|i₁=(r−1)δ+1, (r−1)δ+2, . . . , (r−1)δ+1+L_{c}}
wherein r=1, . . . r_{c}^{u}; wherein r_{c}^{u} is said total number of said length segments;
(d) computing vector pair similarities Sᵥₚ(i₁, j₁)=Fᵥₚ(aᵢ_{ₗ}^{u}, mⱼ_{ₗ}^{v}^{_{c}}^{C}) between all said input vectors {aᵢ_{ₗ}^{u}|i₁=(r−1)δ+1, (r−1)δ+2, . . . , (r+1)δ+1+L_{c}} of said input array segment [A(r)]_{c}^{u} and all said stored vectors {m^{v}^{_{c}}^{C}ⱼ_{₁}|j₁=1 . . . lₗ^{v}^{_{c}}^{C}} of said stored array [M]^{v}^{_{c}}^{C} wherein the similarity function Fᵥₚ(aᵢ_{ₗ}^{u}, mⱼ_{ₗ}^{v}^{_{c}}^{C}) is inverse function of the multidimensional distance an between said input vector aᵢ_{ₗ}^{u} and said stored vector mⱼ_{ₗ}^{v}^{_{c}}^{C} wherein said inverse function Fᵥₚ(aᵢ_{ₗ}^{u}, mⱼ_{ₗ}^{v}^{_{c}}^{C}) increases when said multidimensional distance decreases and said inverse function Fᵥₚ(aᵢ_{ₗ}^{u}, mⱼ_{ₗ}^{v}^{_{c}}^{C}) decreases when said multidimensional distance increases;
(e) defining a bipartite graph which represents said input array segment [A(r)]_{c}^{u} and said stored array [M]^{v}^{_{c}}^{C} wherein each of the input nodes {i₁} of the first part of said bipartite graph is attached to one vector of said input vectors {aᵢ_{₁}^{u}|i₁=(r−1)δ+1, (r−1)δ+2, . . . , (r−1)δ+1+L_{c}} and wherein each of the stored nodes of the second part {j₁} of said bipartite graph is attached to one of said stored vectors {m^{v}^{_{c}}^{C}ⱼ_{₁}|j₁=1 . . . lₗ^{v}^{_{c}}^{C}} wherein each said input node of the first part has links to all said stored nodes {j₁} of the second part wherein each said link L(i₁, j₁) connects said input node i₁ attached to said input vector aᵢ_{ₗ}^{u} with said stored node j₁ attached to said stored vector mⱼ_{ₗ}^{v}^{_{c}}^{C} wherein each said link L(i₁, j₁) has a link weight which is equal to said vector pair similarity Sᵥₚ(i₁, j₁)=Fᵥₚ(aᵢ_{ₗ}^{u}, mⱼ_{ₗ}^{v}^{_{c}}^{C}) between said input vector aᵢ_{ₗ}^{u} and said stored vector mⱼ_{₁}^{v}^{_{c}}^{C} it connects;
(f) defining a sequential link set as a set of said links L(i₁, j₁) in said bipartite graph wherein all links in said sequential link set fulfill a sequencing requirement wherein said sequencing requirement allows to include in said sequential link set only said links which have a mutual sequential relation wherein any two said links . . . L(i₁^{α}, j₁^{β}) . . . Lᵢ_{₁}^{λ}, j₁^{δ}) . . . with said mutual sequential relation must fulfill the following four conditions: (I) α≠λ (II) β≠δ (III) if α<λ then β<δ (IV) if α>λ then β>δ; wherein the notations (i₁^{α}, j₁^{β}),(i₁^{λ}, j₁^{δ}) represent various concrete values of (i₁, j₁) respectively of actual said links L(i₁, j₁);
(g) using the method of dynamic programming to compute the optimal-sequential said bipartite graph matching wherein said optimal-sequential bipartite graph is defined as said bipartite graph with a sequential links set {L(i₁, j₁)} wherein said sequential links set {Lᵢ_{₁}, j₁)} has a total sum of said link weights which is the largest among all said sequential link sets possible in said bipartite graph;
(h) allocating new said link weights to all said links L(i₁, j₁) which have said link weights Sᵥₚ(i₁, j₁) smaller than a predetermined threshold link weight, wherein said new said link weight: SNᵥₚ(i₁, j₁)=FNᵥₚ(aᵢ_{ₗ}^{u}, mⱼ_{ₗ}^{v}^{_{c}}^{C})≦0 is a predetermined penalty function FNᵥₚ(aᵢ_{ₗ}^{u}, mⱼ_{ₗ}^{v}^{_{c}}^{C})≦0 of said input vectors aᵢ_{ₗ}^{u} and said stored vectors mⱼ_{ₗ}^{v}^{_{c}}^{C}
(i) said method of dynamic programming computes said optimal-sequential bipartite graph matching by gradually increasing the size of said optimal-sequential bipartite graph starting with defining an initial said bipartite graph by initiating an input nodes list I_{f}={i₁¹} wherein list size: f=1, wherein second part of said bipartite graph has the full set of said stored nodes {j₁}, listing in each said stored node j₁ said links L(i₁, j_{β}) and said link weights Sᵥₚ(i₁, j₁) and recording said stored node j₁ with the highest said link weight Sᵥₚ(i₁, j₁);
(j) increasing said input nodes list by one I_{f}={i₁¹,i₁²} wherein said list size: f=2 and constructing said optimal-sequential bipartite graph G_{f} which have as said input nodes said input nodes list I_{f}={i₁¹,i₁²} and as said stored nodes said full set of said stored nodes: {j₁}, finding said optimal-sequential bipartite graph with two said links L(i₁², j₁^{φ), L(i}₁¹, j₁^{θ}) wherein said links are said sequential link set wherein said sequencing requirement is: φ<θ≦β wherein the two said links listed have maximal said total sum S_{f} of two said link weights of optimal-sequential bipartite graph G_{f} wherein f=2; recording said maximal said total sum of said link weights S_{f};
(k) increasing said list size by one f=f+1; increasing said input nodes list by one I_{f}={i₁¹, i₁², . . . , i₁^{f}} wherein previous said node list was I_{f-1}={i₁¹, i₁², . . . , i₁^{f-1}}, and constructing said optimal-sequential bipartite graph G_{f} which has as said input nodes said input nodes list I_{f}={i₁¹, i₁², . . . , i₁^{f}} and as said stored nodes said full set of said stored nodes: {j₁} finding said sequential links set with g links wherein g g≦f is a maximal number possible in said optimal-sequential bipartite graph G_{f} wherein said sequential link set includes maximal number of links possible in said optimal-sequential bipartite graph G_{f} including said links with negative weights whenever positive ones are not available, wherein said links listed have the maximal said total sum: S_{g} of g said link weights possible in said optimal-sequential bipartite graph G_{f} wherein if a number n_{α} of said input nodes and a number n_{β} of said stored nodes do not have said links which can be included in said optimal-sequential bipartite graph G_{f} then the overall sum: S_{f} of said weights for G_{f} which includes said total sum S_{g} of g said link weights and the nodes without said links is computed by: S_{f}=S_{g}−N_{w}(n_{α}+n_{β}) wherein N_{w} is a predetermined empty weight constant;
(l) repeating step (k) if f<k₁^{u} otherwise if f=k₁^{u} all said input nodes {i₁} have been included in said list of said input nodes, advancing to step (m);
(m) listing g≦k₁^{u} said links with the highest said total sum of said link weights S_{g} and recording said overall sum S_{f} for G_{f} wherein f=k₁^{u}, also recording that S_{f} is equal to said optimal-sequential total similarity measure: S_{f}=S{[A(r)]_{c}^{u}, [M]^{v}^{_{c}}^{C}} between said input array segment [A(r)]_{c}^{u} and said stored array [M]^{v}^{_{c}}^{C};
(n) returning to step (c) if r<r_{c}^{u}+1, otherwise ending 1D algorithm.

11. Claim number 9 wherein said algorithm which computes 1D similarity measure S{1DArray^{u}(i₁), 1DArray^{v}^{_{c}}^{c} (j₁)} between said input sequence 1DArray^{u}(i₁) and said stored sequence 1DArray^{v}^{_{c}}^{C}(j₁) comprising:
(a) computing vector pair similarities Sᵥₚ(i₁, j₁)=Fᵥₚ(aᵢ_{ₗ}^{u},mⱼ_{ₗ}^{v}^{_{c}}^{C}) between all said input vectors {a^{u}ᵢ_{ₗ}|i₁=1 . . . k₁^{u}} of said input sequence 1DArray^{u}(iᵢ) and all said stored vectors {m^{v}^{_{c}}^{C}ⱼ_{ₗ}|=1 . . . lₗ^{v}^{_{c}}^{C}} of said stored sequence 1DArray^{v}^{_{c}}^{C}(j₁) wherein the similarity function Fᵥₚ(aᵢ_{ₗ}^{u},mⱼ_{ₗ}^{v}^{_{c}}^{C}) is an inverse function of the multidimensional distance between said input vector aᵢ_{ₗ}^{u} and said stored vector mⱼ_{ₗ}^{v}^{_{c}}^{C} wherein said inverse function Fᵥₚ(aᵢ_{ₗ}^{u},mⱼ_{ₗ}^{v}^{_{c}}^{C}) increases when said multidimensional distance decreases wherein said inverse function Fᵥₚ(aᵢ_{ₗ}^{u},mⱼ_{ₗ}^{v}^{_{c}}^{C}) decreases when said multidimensional distance increases;
(b) defining a bipartite graph which represents said input sequence 1DArray^{u}(i₁) and said stored sequence 1DArray^{v}^{_{c}}^{C}(j₁) wherein each of the input nodes {i₁} of the first part of said bipartite graph is attached to one of said input vector {a^{u}ᵢ_{ₗ}|i₁=1 . . . kₗ^{u}} and wherein each of the stored nodes of the second part {j₁} of said bipartite graph is attached to one of said stored vectors {m^{v}^{_{c}}^{C}ⱼ_{₁}|j₁=1 . . . lₗ^{v}^{_{c}}^{C}} wherein each said input node of the first part has links to all said stored nodes {j₁} of the second part wherein each said link L(i₁, j₁) connects said input node i₁ attached to said input vector a^{u}ᵢ_{₁} with said stored node j₁ attached to said stored vector m^{v}^{_{c}}^{C}ⱼ_{₁} wherein each said link L(i₁, j₁) has a link weight which is equal to said vector pair similarity Sᵥₚ(i₁, j₁)=Fᵥₚ(aᵢ_{ₗ}^{u},mⱼ_{ₗ}^{v}^{_{c}}^{C}) between said input vector aᵢ_{ₗ}^{u} and said stored vector mⱼ_{₁}^{v}^{_{c}}^{c} it connects;
(c) defining a sequential link set as a set of said links L(i₁, j₁) in said bipartite graph wherein all links in said sequential link set fulfill a sequencing requirement wherein said sequencing requirement allows to include in said sequential link set only said links which have a mutual sequential relation wherein any two said links . . . , L(i₁^{α}, j₁^{β}) . . . L(i₁^{λ}, j₁^{δ}) . . . with said mutual sequential relation must fulfill the following four conditions: (I) α≠λ (II) β≠δ (III) if α<λ then β<δ (IV) if α>δ then β>δ; wherein the notations i₁^{α}, j₁^{β}, i₁^{λ}, j₁^{δ} represent various concrete values of respectively;
(d) using the method of dynamic programming to compute the optimal-sequential said bipartite graph matching wherein said optimal-sequential bipartite graph is defined as said bipartite graph with a sequential links set {L(i₁, j₁)} wherein said sequential links set {L(i₁, j₁)} has a total sum of said link weights which is the largest among all said sequential link sets possible in said bipartite graph;
(e) allocating new said link weights to all said links L(i₁, j₁) which have said link weights Sᵥₚ(i₁, j₁) smaller than a predetermined threshold link weight, wherein said new said link weight: SNᵥₚ(i₁, j₁)=FNᵥₚ(aᵢ_{ₗ}^{u},mⱼ_{ₗ}^{v}^{_{c}}^{C})≦0 is a predetermined penalty function FNᵥₚ(aᵢ_{ₗ}^{u},mⱼ_{ₗ}^{v}^{_{c}}^{C})≦0 of said input vectors aᵢ_{ₗ}^{u} and said stored vectors mⱼ_{ₗ}^{v}^{_{c}}^{C};
(f) said method of dynamic programming computes said optimal-sequential bipartite graph matching by gradually increasing the size of said optimal-sequential bipartite graph starting with defining an initial said bipartite graph by initiating an input nodes list I_{f}={i₁¹} wherein list size: f=1, wherein second part of said bipartite graph has the full set of said stored nodes {j₁}, recording in each said stored node j₁ said links L(i₁, j_{β}) and said link weights Sᵥₚ(i₁, j₁) and recording said stored node j₁ with the highest said link weight Sᵥₚ(i₁, j₁);
(g) increasing said input nodes list by one I_{f}={i₁¹,i₁²} wherein said list size: f=2 and constructing said optimal-sequential bipartite graph G_{f} which have as said input nodes said input nodes list I_{f}={i₁¹,i₁²} and as said stored nodes said full set of said stored nodes: {j₁}, finding said optimal-sequential bipartite graph with two said links L(i₁², j₁^{φ}), L(i₁¹, j₁^{θ}) wherein said links are said sequential link set wherein said sequencing requirement is: φ<θ≦β wherein the two said links listed have maximal said total sum S_{f} of two said link weights of optimal-sequential bipartite graph G_{f} wherein f=2; recording said maximal said total sum of said link weights S_{f};
(h) increasing said list size by one f=f+1; increasing said input nodes list by one I_{f}={i₁¹, i₁², . . . , i₁^{f}} wherein previous said node list was I_{f-1}={i₁¹, i₁², . . . , i₁^{f-1}}, and constructing said optimal-sequential bipartite graph G_{f} which has as said input nodes said input nodes list I_{f}={i₁^{l}, i₁², . . . , i₁^{f}} and as said stored nodes said full set of said stored nodes: {j₁} finding said sequential links set with g links wherein g≦f is a maximal number possible in said optimal-sequential bipartite graph G_{f} wherein said sequential link set includes maximal number of links possible in said optimal-sequential bipartite graph G_{f} including said links with negative weights whenever positive ones are not available, wherein said links listed have the maximal said total sum: S_{g} of g said link weights possible in said optimal-sequential bipartite graph G_{f} wherein if a number n_{α} of said input nodes and a number n_{β} of said stored nodes do not have said links which can be included in said optimal-sequential bipartite graph G_{f} then the overall sum: S_{f} of said weights for G_{f} which includes said total sum S_{g} of g said link weights and the nodes without said links is computed by: S_{f}=S_{g}−N_{w}(n_{α}+n_{β}) wherein N_{w} is a predetermined empty weight constant;
(i) repeating step (h) if f<k₁^{u} otherwise if f=kₗ^{u} ending the process when all said input nodes {i₁} have been included in said list of said input nodes;
(j) listing g≦k₁^{u} said links with the highest said total sum of said link weights S_{g} and recording said overall sum S_{f} for G_{f} wherein f=k₁^{u}, also noting that S_{f} is equal to said optimal-sequential total similarity measure: S_{f}=S{1DArray^{u}(i₁), 1DArray^{v}^{_{c}}^{C}(j₁)} between said input sequence 1DArray^{u}(i₁) and stored sequence 1DArray^{v}^{_{c}}^{C}(j₁).

12. Claim number 11 wherein said method of dynamic programming to compute said optimal-sequential said bipartite graph matching wherein said process initiating in step (f) starts by constructing said input node list starting with the last said input node i₁^{k}^{₁}^{^{α}} and proceeds in reverse order ending at including in said list said input node i₁¹.

13. Claim number 11 wherein constructing an indexing method for efficient detection of the largest said similarity measures
{S{[A]^{u},[M^{v}^{_{c}}^{C}]}} between said input array [A]^{u} and said stored arrays {[M]^{v}^{_{c}}^{C}} wherein: [A]^{u}={a^{u}ᵢ_{ₗ}|i₁=1 . . . k₁^{u}} and
{[M]^{v}^{_{c}}^{C}}={{mᵢ_{ₗ}^{v}^{_{c}}^{C}|i₁=1, 2, . . . , lₗ^{v}^{_{c}}^{C}}}
(a) for a predetermined said input pattern number u all said input vectors aᵢ_{ₗ}^{u} are indexed into a p dimensional data structure Δₚ which stores all said stored vectors mⱼ_{ᵢ}^{v}^{_{c}}^{C} of said stored arrays {[M]^{v}^{_{c}}^{C}} wherein both said input vectors aᵢ_{₁}^{u} and said stored vectors mⱼ_{₁}^{v}^{_{c}}^{C} are p dimensional;
(b) for each one of said input vectors aᵢ_{₁}^{u} which is indexed into said data structure Δₚ all said stored vectors mⱼ_{₁}^{v}^{_{c}}^{C} which are within a predetermined Euclidean distance dₘₐₓ: d{aᵢ_{₁}^{u},mⱼ_{₁}^{v}^{_{c}}^{C}}≦dₘₐₓ are retrieved;
(c) all said retrieved stored vectors are separated into their original said stored arrays: {[M]^{v}^{_{c}}^{C}};
(d) a predetermined selection function yields selection scores to each of said stored arrays said selection function is dependent on the number of retrieved said stored vectors mⱼ_{₁}^{v}^{_{c}}^{C} which belong to each said stored array, their Euclidean distances d{aᵢ_{₁}^{u},mⱼ_{₁}^{v}^{_{c}}^{C}} from their indexing said input vectors aᵢ_{₁}^{u} and the sum of indices differences between their said indexing input vectors and said retrieved said stored vectors: Σ[(i₁¹−j₁¹)²+ . . . +(i₁^{k}^{₁}^{^{u}}−j₁^{k}^{ₗ}^{^{u}})²]^{1/2};
(e) said a predetermined number of stored arrays [M^{v}^{_{c}}^{C}] with the highest said selection scores are selected for further computations of said similarity measures: {S{[A]^{u},[M^{v}^{_{c}}^{C}]}};
(f) computing said similarity measures {S{[A]^{u},[M^{v}^{_{c}}^{C}]}} of [A]^{u} with each of said selected stored arrays [M^{v}^{_{c}}^{C}] as {S{[A]^{u},[M^{v}^{_{c}}^{C}]}}=S{1DArray^{u}(i₁), 1DArray^{v}^{_{c}}^{C}(j₁)} wherein 1DArray^{u}(i₁)={a^{u}ᵢ_{₁}|i₁=1 . . . k₁^{u}}=[A]^{u} and wherein
1DArray^{c}^{_{c}}^{C}(j₁)={m^{v}^{_{c}}^{C}ⱼ_{₁}|=1 . . . l₁^{v}^{_{c}}^{C}}=[M]^{v}^{_{c}}^{C};
(g) selecting said stored array [M^{v}^{_{c}}^{C}] with the highest said similarity measure as the most similar to said input array [A]^{u} and said input array can be classified into the same class c of the selected said stored array [M]^{v}^{_{c}}^{C} if said similarity measure is larger than a predetermined similarity threshold value.

14. Claim number 10 wherein one dimensional said input array [A]^{u} represents a continuous speech signal that contains spoken words and wherein sets of one dimensional said stored arrays {[M]^{v}^{_{c}}^{C}} which represent a collection of exemplar words wherein each class c includes a set of V_{c} said stored arrays {[M]^{v}^{_{c}}^{C}} which represent the same spoken said exemplar word wherein classification of said spoken words in said input array [A]^{u} is performed by the following steps:
(a) separating said exemplar words represented by {[M]^{v}^{_{c}}^{C}} into phonemes by dividing each said stored array [M^{v}^{_{c}}^{C}] into stored segments [Hₕ^{v}^{_{c}}^{C}] by clustering similar said stored vectors mⱼ_{₁}^{v}^{_{c}}^{C} which are also temporal neighbors wherein said stored array [M]^{v}^{_{c}}^{C}={mᵢ_{₁}^{v}^{_{c}}^{C}|1, 2, . . . , l₁^{v}^{_{c}}^{C}} is divided into nh(v_{c}c)
said stored segments: [M]^{v}^{_{c}}^{C}=[H₁^{v}^{_{c}}^{C}]+ . . . +[Hₙₕ₍ᵥ_{^{c}}_{C)}^{v}^{_{c}}^{C}] wherein each said stored segment [H_{ω}]v^{_{c}}^{C} has the following said stored vectors [H_{ω}]^{v}^{_{c}}^{C}|j₁=j_{ω}, . . . , j_{ω}+μ_{ω}; wherein ω=1, . . . , nh(v_{c}c); is the serial number of said stored segment, wherein 1≦j_{ω}; j_{ω}+μ_{ω}≦l₁^{v}^{_{c}}^{C} and wherein said clustering minimizes a predetermined clustering criterion which is a function of mutual distances of said stored vectors: {mⱼ_{₁}^{v}^{_{c}}^{C}|j₁=j_{ω}, . . . , j_{ω}+μ_{ω}} within each said stored segment: [H_{ω}]^{v}^{_{c}}^{C};
(b) computing the average length of each said class c:
$${L}_{c} = {\sum }_{{v}_{c} = 1}^{{V}_{c}} {l}_{1}^{{v}_{c} c}$$
(c) for each class c, dividing the total length k₁^{u} of said input array [A]^{u} into partially overlapping length segments of lengths: L_{c} wherein said length segments: L_{c}^{u}(r)=[(r−1)δ+1, (r−1)δ+2, . . . , (r−1)δ+1+L_{c}] wherein the overlap: δ=┌φL_{c}┐ is the lowest integer which is greater or equal to a predetermined fraction φ of said segment length L_{c} wherein total number of partially overlapping said length segments is: r_{c}^{u}=└(k₁^{u}−L_{c})/δ+1┘; wherein r_{c}^{u} is the largest integer smaller or equal to (k₁^{u}−L_{c})/δ+1;
(d) setting c=0;
(e) setting v_{c}=0 c [symbol] c+1;
(f) setting r=0; v_{c} [symbol] v_{c}+1;
(g) for r [symbol] r+1
dividing said input array [A]^{u} into said input array partially overlapping array segments: [A(r)]_{c}^{u} wherein [A(r)]_{c}^{u}={aᵢ_{₁}^{u}|i₁=(r−1)δ+1, (r−1)δ+2, . . . , (r−1)δ+1+L_{c}} wherein r=1, . . . , r_{c}^{u}; wherein r_{c}^{u} is said total number of said length segments, next, all said input vectors aᵢ_{₁}^{u} in said input array segment [A(r)]_{c}^{u} are indexed into a p dimensional data structure Δₚ which stores all said stored vectors mⱼ_{ᵢ}^{v}^{_{c}}^{C} of said stored arrays {[M]^{v}^{_{c}}^{C}} wherein both said input vectors aᵢ_{₁}^{u} and said stored vectors mⱼ_{₁}^{v}^{_{c}}^{C} are p dimensional;
(h) for each one of said input vectors aᵢ_{₁}^{u} which is indexed into said data structure Δₚ all said stored vectors mⱼ_{₁}^{v}^{_{c}}^{C} which are within a predetermined Euclidean distance dₘₐₓ: d{aᵢ_{₁}^{u},mⱼ_{₁}^{v}^{_{c}}^{C}}≦dₘₐₓ are retrieved;
(i) all said retrieved stored vectors are separated into their original said stored arrays: {[M]^{v}^{_{c}}^{C}} wherein v_{c}=1, . . . , V_{c};
(j) a predetermined selection function yields selection scores to each of said stored arrays, said selection function is dependent on the number of retrieved said stored vectors mⱼ_{₁}^{v}^{_{c}}^{C} which belong to each said stored array and their Euclidean distances d{aᵢ_{₁}^{u},mⱼ_{₁}^{v}^{_{c}}^{C}} from their indexing said input vectors aᵢ_{₁}^{u};
(k) for a predetermined selection threshold all said stored arrays [M^{v}^{_{c}}^{C}] with said selection scores which are greater than said selection threshold are selected for further computations of said similarity measures: {S{[A(r)]_{c}^{u},[M^{v}^{_{c}}^{C}]}};
(l) computing said similarity measures {S{[A(r)]_{c}^{u},[M^{v}^{_{c}}^{C}]}} of [A(r)]_{c}^{u} with each of selected said stored arrays [M^{v}^{_{c}}^{C}]
(m) computing said sum of said links weights of said segment [H_{ω}]^{v}^{_{c}}^{C} with said input array [A(r)]_{c}^{u} for ω=1, . . . , nh(v_{c}c); if one of said segment has said sum of said links weights which is smaller than a predetermined segment threshold, said stored array which has this segment is removed from the list of selected said
stored arrays [M^{v}^{_{c}}^{C}];
(n) if r<r_{c}^{u}+1 returning to step (g);
(o) if v_{c}<V_{c}+1 returning to step (f);
(p) if c<C+1 returning to step (e);
(q) selecting said stored array [M^{v}^{_{c}}^{C}] with the highest said similarity measure as the most similar to said input array [A]^{u} and said input array can be classified into the same class c of the selected said stored array [M^{v}^{_{c}}^{C}] if said similarity measure is larger than a predetermined similarity threshold value.

15. Claim number 1 wherein said number of dimensions of said input array is: q=2, wherein said number of dimensions of said stored array: q=2, wherein said input sequence of said input vectors is defined as one dimensional input array denoted by 1DArray^{u}(i₁|a₂) wherein 1DArray^{u}(i₁|a₂)={e^{u}ᵢ_{₁}_{,i}_{₂}|i₁=1 . . . k₁^{u}; i₂=a₂} is said one dimensional part of said input array [A]^{u}, wherein a₂=1, . . . , k₂^{u};
wherein said stored sequence of said stored vectors is defined as one dimensional stored array denoted by 1DArray^{v}^{_{c}}^{C}(j₁|b₂) wherein 1DArray^{v}^{_{c}}^{C}(j₁|b₂)={m^{v}^{_{c}}^{C}ⱼ_{₁}_{,j}_{₂}|j₁=1 . . . l₁^{v}^{_{c}}^{C}|j₂=b₂} is said one dimensional part of said stored array [M]^{v}^{_{c}}^{C} wherein b₂=1, . . . , l₂^{v}^{_{c}}^{C}.

16. Claim number 15 wherein said 1D algorithm which computes 1D similarity measure S{1DArray^{u}(j₁|a₂), 1DArray^{v}^{_{c}}^{C}(j₁|b₂)} between said input sequence 1DArray^{u}(i₁|a₂) and stored sequence 1DArray^{v}^{_{c}}^{C}(j₁|b₂) comprising:
(a) computing vector pair similarities Sᵥₚ(i₁, j₁|a₂,b₂)=Fᵥₚ(eᵢ_{₁}_{,a}_{₂}^{u},mⱼ_{₁}_{,b}_{₂}^{v}^{_{c}}^{C}) between all said input vectors {e^{u}ᵢ_{₁}_{,i}_{₂}|i₁=1 . . . kₗ^{u}; i₂=a₂} of said input sequence 1DArray^{u}(i₁|a₂) and all said stored vectors {m^{v}^{_{c}}^{C}ⱼ_{₁}_{,j}_{₂}|j₁=1 . . . l₁^{v}^{_{c}}^{C}|j₂=b₂} of said stored sequence 1DArray^{v}^{_{c}}^{C}(j₁|b₂) wherein similarity function Fᵥₚ(ei_{₁}_{,a}_{₂}^{u},mⱼ_{ᵢ}_{,b}_{₂}^{v}^{_{c}}^{C}) is an inverse function of the multidimensional distance between said input vector eᵢ_{₁}_{,a}_{₂}^{u} and said stored vector mⱼ_{₁}_{,b}_{₂}^{v}^{_{c}}^{C} wherein said similarity function Fᵥₚ(eᵢ_{₁}_{,a}_{₂}^{u},mⱼ_{₁}_{,b}_{₂}^{v}^{_{c}}^{C}) increases when said multidimensional distance decreases, wherein said similarity function Fᵥₚ(eᵢ_{₁}_{,a}_{₂}^{u},mⱼ_{₁}_{,b}_{₂}^{v}^{_{c}}^{C}) decreases when said multidimensional distance increases;
(b) defining a bipartite graph which represents said input sequence 1DArray^{u}(i₁|a₂) and said stored sequence 1DArray^{v}^{_{c}}^{C}(j₁|b₂) wherein said bipartite graph has two parts wherein the first part consists of input nodes wherein the second part consists of stored nodes wherein each of said input nodes {i₁|a₂}={i₁|i₁=1, . . . , k₁^{u};a₂} of said first part of said bipartite graph is attached to one of said input vectors {e^{u}ᵢ_{₁}_{,i}_{₂}|i₁=1 . . . k₁^{u};i₂=a₂} and wherein each of said stored nodes of said second part {j₁|b₂}={j₁|j₁=1, . . . , l₁^{v}^{_{c}}^{C};b₂} of said bipartite graph is attached to one of said stored vectors {m^{v}^{_{c}}^{C}ⱼ_{₁}_{,j}_{₂}|j₁=1 . . . , l₁^{v}^{_{c}}^{C}|j₂=b₂} wherein each said input node of the first part has links to all said stored nodes {j₁|b₂} of the second part wherein each said link L(i₁, j₁|a₂,b₂) connects said input node i₁ attached to said input vector eᵢ_{₁}_{,a}_{₂}^{u} with said stored node j₁ attached to said stored vector mⱼ_{₁}_{,b}_{₂}^{v}^{_{c}}^{C} wherein each said link L(i₁, j₁|a₂, b₂) has a link weight which is equal to said vector pair similarity Sᵥₚ^{uv}^{_{c}}^{c}(i₁, j₁|a₂,b₂)=Fᵥₚ(eᵢ_{₁}_{,a}_{₂}^{u},mⱼ_{₁}_{,b}_{₂}^{v}^{_{c}}^{C}) between said input vector eᵢ_{₁}_{,a}_{₂}^{u} and said stored vector mⱼ_{₁}_{,b}_{₂}^{v}^{_{c}}^{C} it connects;
(c) defining a sequential link set as a set of said links L(i₁, j₁|a₂,b₂) in said bipartite graph wherein all said links in said sequential link set fulfill a sequencing requirement wherein said sequencing requirement allows to include in said sequential link set only said links which have a mutual sequential relation wherein any two said links . . . L(i₁=η,j₁=ε|a₂,b₂) . . . L(i₁=λ, j₁=δ|a₂,b₂) . . . with said mutual sequential relation must fulfill the following four conditions: (I) η≠λ (II) ε≠δ (III) if η<λ then ε<δ (IV) if η>λ then ε<δ;
(d) allocating new said link weights: SNᵥₚ^{uv}^{_{c}}^{c}(iᵢ_{₁}, j₁|a₂,b₂) to all said links L(i₁, j₁|a₂,b₂) which have said link weights Sᵥₚ^{uv}^{_{c}}^{c}(i₁, j₁|a₂, b₂)<ThLW smaller than a predetermined threshold link weight: ThLW, wherein Sᵥₚ^{uv}^{_{c}}^{c}(i₁, j₁|a₂,b₂)=SNᵥₚ^{uv}^{_{c}}^{c}(i₁, j₁|a₂,b₂), wherein said new said link weight: SNᵥₚ^{uv}^{_{c}}^{c}(i₁, j₁|a₂,b₂)=FNᵥₚ(eᵢ_{₁}_{,a}_{₂}^{u},mⱼ_{₁}_{,b}_{₂}^{v}^{_{c}}^{C})≦0 is a predetermined penalty function: FNᵥₚ(eᵢ_{₁}_{,a}_{₂}^{u},mⱼ_{₁}_{,b}_{₂}^{v}^{_{c}}^{C})≦0 of said input vectors: eᵢ_{₁}_{,a}_{₂}^{u} and said stored vectors: mⱼ_{₁}_{,b}_{₂}^{v}^{_{c}}^{C};
(e) using said method of dynamic programming to compute the optimal-sequential said bipartite graph matching wherein said optimal-sequential said bipartite graph is defined as said bipartite graph with said sequential links set {L(i₁, j₁|a₂,b₂)} wherein said sequential links set {L(i₁, j₁|a₂,b₂)} has a total sum of said link weights: TsLW_{z}^{uv}^{_{c}}^{c}(a₂,b₂) wherein
$${TsLW}_{z}^{{uv}_{c} c} ( {a}_{2} , {b}_{2} ) = max \{ {\sum }_{{a}_{2} , {b}_{2}}^{ } {S}_{vp}^{{uv}_{c} c} ( {i}_{1} , {j}_{1} \vert {a}_{2} , {b}_{2} ) \}$$
which is the largest among all said sequential link sets possible in said bipartite graph wherein said sequential link set includes maximal number of links possible in said optimal-sequential said bipartite graph including said links with negative weights whenever positive ones are not available, wherein if a number n_{α} of said input nodes and a number n_{β} of said stored nodes do not have said links which can be included in said optimal-sequential said bipartite graph then the grand total said sum of said links weights TsLW^{uv}^{_{c}}^{c}(a₂,b₂) is computed by:
$${TsLW}^{{uv}_{c} c} ( {a}_{2} , {b}_{2} ) = max \{ {\sum }_{{a}_{2} , {b}_{2}}^{ } {S}_{vp}^{{uv}_{c} c} ( {i}_{1} , {j}_{1} \vert {a}_{2} , {b}_{2} ) \} - {N}_{w} ( {n}_{α} + {n}_{β} )$$
wherein N_{w} is a predetermined penalty weight constant;
(f) recording said grand total said sum of said links weights TsLW^{uv}^{_{c}}^{c}(a₂,b₂) as equal to said optimal-sequential total similarity measure: TsLW^{uv}^{_{c}}^{c}(a₂,b₂)=S{1DArray^{u}(i₁|a₂), 1DArray^{v}^{_{c}}^{C}(j₁|b₂)} between said input sequence 1DArray^{u}(i₁|a₂) and stored sequence 1DArray^{v}^{_{c}}^{C}(j₁|b₂).

17. Claim number 16 wherein said 1D algorithm which computes said optimal-sequential total similarity measures: {S{1DArray^{u}(i₁|a₂), 1DArray^{v}^{_{c}}^{C}(j₁|b₂)}} between said input sequence 1DArray^{u}(i₁|a₂) and stored sequence 1DArray^{v}^{_{c}}^{C}(j₁|b₂) wherein a₂=1, . . . , k₂^{u};b₂=1, . . . , l₂^{v}^{_{c}}^{C}, wherein defining a set of similarity links: {SL^{uv}^{_{c}}^{c}(a₂,b₂)} which have similarity link weights: {SLW^{uv}^{_{c}}^{c}(a₂,b₂)} which are equal to said optimal-sequential total similarity measures:
{S{1DArray^{u}(i₁|a₂), 1DArray^{v}^{_{c}}^{C}(j₁|b₂)}}
wherein {SLW^{uv}^{_{c}}^{c}(a₂,b₂)}={S{1DArray^{u}(i₁|a₂), 1DArray^{v}^{_{c}}^{C}(j₁|b₂)}},
wherein said algorithm which computes said similarity measures {S{[A]^{u},[M]^{v}^{_{c}}^{C}}} between said input array [A]^{u} and said stored arrays {[M]^{v}^{_{c}}^{C}} comprising:
(a) building a similarity bipartite graph which represents said input sequence 1DArray^{u}(a₂) and said stored sequence 1DArray^{v}^{_{c}}^{C}(b₂) wherein said similarity bipartite graph has two parts, wherein the first part consists of input nodes {a₂}={a₂|a₂=1, . . . , k₂^{u}} wherein the second part consists of stored nodes {b₂}={b₂|b₂=1, . . . , l₂^{v}^{_{c}}^{C}}, wherein each said input node a₂ of the first part has similarity links to all said stored nodes {b₂} of the second part wherein each said similarity link SL^{uv}^{_{c}}^{c}(a₂,b₂) connects said input node a₂ with said stored node b₂ wherein each said similarity link SL^{uv}^{_{c}}^{c}(a₂,b₂) has said similarity link weight SLW^{uv}^{_{c}}(a₂,b₂);
(b) defining a sequential similarity link set as a set of said similarity links SL^{uv}^{_{c}}^{c}(a₂,b₂) in said bipartite graph wherein all said similarity links in said sequential similarity link set fulfill said sequencing requirement wherein said sequencing requirement allows to include in said sequential similarity link set only said similarity links which have a mutual sequential relation wherein any two said similarity links . . . SL^{uv}^{_{c}}^{c}(a₂=η, b₂=ε) . . . SL^{uv}^{_{c}}^{c}(a₂=λ, b₂=δ) . . . with said mutual sequential relation must fulfill the following four conditions: (I) η≠λ (II) ε≠δ (III) if η<λ then ε<δ (IV) if η>λ then ε<δ;
(c) allocating new said similarity link weights to all said similarity links {SL^{uv}^{_{c}}^{c}(a₂,b₂)} which have said similarity link weights SLW^{uv}^{_{c}}^{C} (a₂, b₂) smaller than a predetermined threshold similarity link weight: TSLW^{uv}^{_{cv}}^{c} wherein said new said similarity link weight: SLW^{uv}^{_{c}}^{c} (a₂,b₂)=NSLW^{uv}^{_{c}}^{c}(a₂,b₂)=P^{uv}^{_{c}}^{c}≦0 wherein P^{uv}^{_{c}}^{c}≦0 is a predetermined penalty function of said serial number of said input array u, said serial number of stored array: v_{c} within said class c and said class c;
(d) using said method of dynamic programming to compute said optimal-sequential said similarity bipartite graph wherein said optimal-sequential said similarity bipartite graph is defined as said similarity bipartite graph with said sequential similarity links set: {SL^{uv}^{_{c}}^{c}(a₂,b₂)} wherein said sequential similarity links set {SL^{uv}^{_{c}}^{c}(a₂, b₂)} has a total sum of said similarity link weights TSLW^{uv}^{_{c}}^{c}(a₂,b₂) wherein
$${TsLW}^{{uv}_{c} c} ( {a}_{2} , {b}_{2} ) = {\sum }_{{a}_{2} , {b}_{2}}^{ } {SLW}^{{uv}_{c} c} ( {a}_{2} , {b}_{2} )$$
which is the largest among all said sequential similarity link sets possible in said similarity bipartite graph;
(e) recording said similarity measures {S{[A]^{u},[M]^{v}^{_{c}}^{C}}} between said input array [A]^{u} and said stored arrays {[M]^{v}^{_{c}}^{C}} as equal to: {S{[A]^{u},[M]^{v}^{_{c}}^{C}}}, {TSLW^{uv}^{_{c}}^{c}(a₂,b₂)}.

18. Claim number 15 wherein said 1D algorithm which computes 1D similarity measure S{1DArray^{u}(i₁|a₂), 1DArray^{v}^{_{c}}^{C}(j₁|b₂)} between said input sequence 1DArray^{u}(i₁|a₂) and stored sequence 1DArray^{v}^{_{c}}^{C}(j₁|b₂) comprising:
(a) computing vector pair similarities Sᵥₚ(i₁, j₁|a₂, b₂)=Fᵥₚ(eᵢ_{₁}_{,a}_{₂}^{u},mⱼ_{₁}_{,b}_{₂}^{v}^{_{c}}^{C}) between all said input vectors {e^{u}ᵢ_{₁}_{,i}_{₂}|i₁=1 . . . k₁^{u};i₂=a₂} of said input sequence 1DArray^{u}(i₁|a₂) and all said stored vectors {m^{v}^{_{c}}^{C}ⱼ_{₁}_{,j}_{₂}|j₁=1 . . . l₁^{v}^{_{c}}^{C}|j₂=b₂} of said stored sequence 1DArray^{v}^{_{c}}^{C}(j₁|b₂) wherein similarity function Fᵥₚ(eᵢ_{₁}_{,a}_{₂}^{u},mⱼ_{₁}_{,b}_{₂}^{v}^{_{c}}^{C}) is an inverse function of the multidimensional distance between said input vector eᵢ_{₁}_{,a}_{₂}^{u} and said stored vector mⱼ_{₁}_{,b}_{₂}^{v}^{_{c}}^{C} wherein said similarity function Fᵥₚ(eᵢ_{₁}_{,a}_{₂}^{u},mⱼ_{₁}_{,b}_{₂}^{v}^{_{c}}^{C}) increases ncrees when said multidimensional distance decreases, wherein said similarity function Fᵥₚ(eᵢ_{₁}_{,a}_{₂}^{u},mⱼ_{₁}_{,b}_{₂}^{v}^{_{c}}^{C}) decreases when said multidimensional distance increases;
(b) defining a bipartite graph which represents said input sequence 1DArray^{u}(i₁|a₂) and said stored sequence 1DArray^{v}^{_{c}}^{C}(j₁|b₂) wherein said bipartite graph has two parts wherein the first part consists of input nodes wherein the second part consists of stored nodes wherein each of said input nodes {i₁} of said first part of said bipartite graph is attached to one of said input vectors {e^{u}ᵢ_{₁}_{,i}_{₂}|i₁=1 . . . k₁^{u};i₂=a₂} and wherein each of said stored nodes of said second part {j₁} of said bipartite graph is attached to one of said stored vectors {m^{v}^{_{c}}^{c}ⱼ_{ᵢ}_{,j}_{₂}|j₁=1 . . . l₁^{v}^{_{c}}^{C}|j₂=b₂} wherein each said input node of the first part has links to all said stored nodes {j₁} of the second part wherein each said link L(i₁, j₁|a₂, b₂) connects said input node i₁ attached to said input vector eᵢ_{₁}_{,a}_{₂}^{u} with said stored node j₁ attached to said stored vector mⱼ_{₁}_{,b}_{₂}^{v}^{_{c}}^{C} wherein each said link L(i₁, j₁|a₂,b₂) has a link weight which is equal to said vector pair similarity Sᵥₚ(i₁, j₁|a₂, b₂)=Fᵥₚ(eᵢ_{₁}_{,a}_{₂}^{u},mⱼ_{₁}_{,b}_{₂}^{v}^{_{c}}^{C}) between said input vector eᵢ_{₁}_{,a}_{₂}^{u} and said stored vector mⱼ_{₁}_{,b}_{₂}^{v}^{_{c}}^{C} connects;
(c) defining a sequential link set as a set of said links L(i₁, j₁|a₂,b₂) in said bipartite graph wherein all said links in said sequential link set fulfill a sequencing requirement wherein said sequencing requirement allows to include in said sequential link set only said links which have a mutual sequential relation wherein any two said links . . . L(i₁=η, j₁=ε|a₂,b₂) . . . L(i₁=λ, j₁=δ|a₂,b₂) . . . with said mutual sequential relation must fulfill the following four conditions: (I) η≠λ (II) ε≠δ (III) if η<λ then ε<δ (IV) if η>λ then ε<δ;
(d) allocating new said link weights: SNᵥₚ(i₁, j₁|a₂,b₂) to all said links L(i₁, j₁|a₂,b₂) which have said link weights Sᵥₚ(i₁, j₁|a₂,b₂)<TLW smaller than a predetermined threshold link weight: TLW, wherein Sᵥₚ(i₁, j₁|a₂,b₂)=SNᵥₚ(i₁, j₁|a₂,b₂), wherein said new said link weight: SNᵥₚ(i₁, j₁|a₂,b₂)=FNᵥₚ(eᵢ_{₁}_{,a}_{₂}^{u},mⱼ_{₁}_{,b}_{₂}^{v}^{_{c}}^{C})≦0 is a predetermined penalty function: FNᵥₚ(eᵢ_{₁}_{,a}_{₂}^{u},mⱼ_{₁}_{,b}_{₂}^{v}^{_{c}}^{C})≦0 of said input vectors: eᵢ_{₁}_{,a}_{₂}^{u} and said stored vectors: mⱼ_{₁}_{,b}_{₂}^{v}^{_{c}}^{C};
(e) using the method of dynamic programming to compute the optimal-sequential said bipartite graph matching wherein said optimal-sequential said bipartite graph is defined as said bipartite graph with said sequential links set {L(i₁, j₁|a₂,b₂)} wherein said sequential links set {L(i₁, j₁|a₂,b₂)} has a total sum of said link weights which is the largest among all said sequential link sets possible in said bipartite graph;
(f) said method of dynamic programming computes said optimal-sequential said bipartite graph matching by gradually increasing the size of said optimal-sequential said bipartite graph starting with defining an initial said bipartite graph by initiating an input nodes list I_{f}={i₁=1} wherein said list size: f=1, wherein said input nodes list denotes all said input nodes of said input part, wherein said second part of said bipartite graph has the full set of said stored nodes {j₁}, listing in each said stored node j₁ said link L(i₁=1, j₁|a₂,b₂) and said link weight Sᵥₚ(i₁=1, j₁|a₂,b₂);
(g) increasing said input nodes list by one I_{f}={i₁=1, i₁=2} wherein said list size: f=2 and constructing said optimal-sequential said bipartite graph G_{f} which have as said input nodes said input nodes list I_{f}={i₁=1, i₁₌2} and as said stored nodes said full set of said stored nodes: {j₁}, finding said optimal-sequential bipartite graph with maximum two said links L(i₁=1, j₁=φ|a₂,b₂), L(i₁=2, j₁=θ|a₂,b₂) wherein said links are said sequential link set wherein said sequencing requirement is: φ<θ≦β wherein the two said links listed have maximal said total sum S_{f} of maximum two said link weights of said optimal-sequential said bipartite graph G_{f}, recording said maximal said total sum of said link weights S_{f};
(h) increasing said list size by one f=f+1; increasing said input nodes list by one I_{f}={i₁=1,i₁=2, . . . , i₁=f} wherein previous said node list was I_{f-1}={i₁=1, i₁₌2, . . . , i₁=f−1} and constructing said optimal-sequential said bipartite graph G_{f} which has as said input nodes said input nodes list I_{f}={i₁=1,i₁=2, . . . , i₁=f} and as said stored nodes said full set of said stored nodes: {j₁} finding said sequential links set with g links wherein g≦f is a maximal number possible in said optimal-sequential bipartite graph G_{f} wherein said sequential link set includes maximal number of links possible in said optimal-sequential said bipartite graph G_{f} including said links with negative weights whenever positive ones are not available, wherein said links listed have the maximal said total sum of g said link weights S_{g}^{uv}^{_{c}}^{c}(a₂,b₂) possible in said optimal-sequential said bipartite graph G_{f} wherein if a number n_{α} of said input nodes and a number n_{β} of said stored nodes do not have said links which can be included in said optimal-sequential said bipartite graph G_{f} then the total said sum of said links weights S^{uv}^{_{c}}^{c}(a₂,b₂) for G_{f} is computed by: S_{f}^{uv}^{_{c}}^{c}(a₂,b₂)=S_{g}^{uv}^{_{c}}^{c}(a₂,b₂)−N_{w}(n_{α}+n_{β}) wherein N_{w} is a predetermined penalty weight constant;
(i) repeating step (h) if f<kₗ^{u} otherwise if f=kₗ^{u} ending the process wherein all said input nodes {i₁} have been included in said list of said input nodes;
(j) listing g≦k₁^{u} said links with the highest said total sum of said link weights S_{g}^{uv}^{_{c}}^{c}(a₂,b₂) and recording said total sum of said link weights S_{f}^{uv}^{_{c}}^{c}(a₂,b₂), wherein S_{f}^{uv}^{_{c}}^{c}(a₂,b₂) is equal to said optimal-sequential total similarity measure: S_{f}^{uv}^{_{c}}^{c}(a₂, b₂)=S{1DArray^{u}(i₁|a₂), 1DArray^{v}^{_{c}}^{C}(j₁|b₂)} between said input sequence 1DArray^{u}(i₁|a₂) and stored sequence 1DArray^{v}^{_{c}}^{C}(j₁|b₂).

19. Claim number 18 wherein said 1D algorithm which computes said optimal-sequential total similarity measures:{S_{f}^{uv}^{_{c}}^{C}(a₂,b₂)}={S{1DArray^{u}(i₁|a₂), 1DArray^{v}^{_{c}}^{C}(j₁|b₂)}} between said input sequence 1 DArray^{u}(i₁|a₂) and stored sequence 1DArray^{v}^{_{c}}^{C}(j₁|b₂) wherein a₂=1, . . . , k₂^{u};b₂=1, . . . l₂^{v}^{_{c}}^{C}, wherein similarity links: {SL^{uv}^{_{c}}^{c}(a₂,b₂)} which have similarity link weights: {SLW^{uv}^{_{c}}^{c}(a₂,b₂)} are equal to said optimal-sequential total similarity measures: {S_{f}^{uv}^{_{c}}^{c}(a₂,b₂)} wherein {SLW^{uv}^{_{c}}^{c}(a₂,b₂)}={S_{f}^{uv}^{_{c}}^{c}(a₂,b₂)}={S{1DArray^{u}(i₁|a₂), 1DArray^{v}^{_{c}}^{c}(j₁|b₂)}}, wherein said algorithm which computes said similarity measures {S{[A]^{u},[M]^{v}^{_{c}}^{c}}} between said input array [A]^{u} and said stored arrays {[M]^{v}^{_{c}}^{c}} comprising:
(a) building a similarity bipartite graph which represents said input sequence 1DArray^{u}(a₂) and said stored sequence 1DArray^{v}^{_{c}}^{c}(b₂) wherein said similarity bipartite graph has two parts, wherein the first part consists of input nodes {a₂}={a₂|a₂=1, . . . , k₂^{u}} wherein the second part consists of stored nodes {b₂}={b₂|b₂=1, . . . , l₂^{v}^{_{c}}^{c}}, wherein each said input node a₂ of the first part has similarity links to all said stored nodes {b₂} of the second part wherein each said similarity link SL^{uv} ^{_{c}}^{c}(a₂,b₂) connects said input node a₂ with said stored node b₂ wherein each said similarity link SL^{uv}^{_{c}}^{c}(a₂,b₂) has said similarity link weight SLW^{uv}^{_{c}}^{c}(a₂,b₂);
(b) defining a sequential similarity link set as a set of said similarity links SL^{uv}^{_{c}}^{c}(a₂,b₂) in said bipartite graph wherein all said similarity links in said sequential similarity link set fulfill said sequencing requirement wherein said sequencing requirement allows to include in said sequential similarity link set only said similarity links which have a mutual sequential relation wherein any two said similarity links . . . SL^{uv}^{_{c}}^{c}(a₂=η,b₂=ε) . . . SL^{uv}^{_{c}}^{c}(a₂=λ,b₂=δ) . . . with said mutual sequential relation must fulfill the following four conditions: (I) η≠λ (II) ε≠δ (III) if η<λ then ε<δ (IV) if η>λ then ε>δ;
(c) allocating new said similarity link weights to all said similarity links {SL^{uv}^{_{c}}^{c}(a₂,b₂)} which have said similarity link weights SLW^{uv}^{_{c}}^{c}(a₂,b₂) smaller than a predetermined threshold similarity link weight: TSLW^{uv}^{_{c}}^{c} wherein said new said similarity link weight: SLW^{uv} ^{_{c}}^{c}(a₂,b₂)=NSLW^{uv}^{_{c}}^{c}(a₂,b₂)=P^{uv}^{_{c}}^{c}≦0 wherein P^{uv}^{_{c}}≦0 is a predetermined penalty function of said serial number of said input array u, said serial number of stored array: v_{c} within said class c and said class c;
(d) using a method of dynamic programming to compute said optimal-sequential said similarity bipartite graph wherein said optimal-sequential said similarity bipartite graph is defined as said similarity bipartite graph with said sequential similarity links set: {SL^{uv}^{_{c}}^{c}(a₂, b₂)} wherein said sequential similarity links set {SL^{uv}^{_{c}}^{c}(a₂,b₂)} has a total sum of said similarity link weights TSLW^{uv}^{_{c}}^{c}(a₂,b₂) wherein
$${TsLW}^{{uv}_{c} c} ( {a}_{2} , {b}_{2} ) = {\sum }_{{a}_{2} , {b}_{2}}^{ } {SLW}^{{uv}_{c} c} ( {a}_{2} , {b}_{2} )$$
which is the largest among all said sequential similarity link sets possible in said similarity bipartite graph;
(e) recording said similarity measures {S{[A]^{u},[M]^{v}^{_{c}}^{c}}} between said input array [A]^{u} and said stored arrays {[M]^{v}^{_{c}}^{c}} as equal to: {S{[A]^{u},[M]^{v}^{_{c}}^{c}}}={TSLW^{uv}^{_{c}}^{c}(a₂,b₂)}.
